(19) United States
(12) Patent Application Publication
(10) Pub. No.: US 2026/0121901 A1
(43) Pub. Date: Apr. 30, 2026

(54) UPLINK RESOURCE MUTING AND PHASE TRACKING REFERENCE SIGNALS FOR DISCRETE FOURIER TRANSFORM SPREAD ORTHOGONAL FREQUENCY DIVISION MULTIPLEXING WAVEFORMS

(71) Applicant: QUALCOMM Incorporated, San Diego, CA (US)

(72) Inventors: Abdelrahman Mohamed IBRAHIM, San Diego, CA (US); Qian ZHANG, Basking Ridge, NJ (US); Muhammad Sayed Khairy ABDELGHAFFAR, San Jose, CA (US)

(21) Appl. No.: 19/284,384

(22) Filed: Jul. 29, 2025

Related U.S. Application Data
(60) Provisional application No. 63/711,498, filed on Oct. 24, 2024.

(51) Int. Cl. H04L 27/26; H04L 5/00; H04W 72/21

(52) U.S. Cl. CPC H04L 27/2636; H04L 5/0051; H04W 72/21

(57) ABSTRACT

Various aspects of the present disclosure generally relate to wireless communication. In some aspects, a user equipment (UE) may receive a configuration associated with one or more of an uplink resource muting or a phase tracking reference signal (PT-RS) for a discrete Fourier transform (DFT) spread orthogonal frequency division multiplexing (OFDM) (DFT-s-OFDM) waveform. The UE may transmit an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration. Numerous other aspects are described.

### CROSS-REFERENCE TO RELATED APPLICATION

This patent application claims priority to U.S. Provisional Patent Application No. 63/711,498, filed on Oct. 24, 2024, entitled “UPLINK RESOURCE MUTING AND PHASE TRACKING REFERENCE SIGNALS FOR DISCRETE FOURIER TRANSFORM SPREAD ORTHOGONAL FREQUENCY DIVISION MULTIPLEXING WAVEFORMS,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods associated with uplink resource muting and phase tracking reference signals (PT-RSs) for discrete Fourier transform (DFT) spread orthogonal frequency division multiplexing (OFDM) (DFT-s-OFDM) waveforms.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example disaggregated network node architecture, in accordance with the present disclosure.

FIG. 3 is a diagram illustrating examples of full duplex (FD) communications, in accordance with the present disclosure.

FIG. 4 is a diagram illustrating examples of FD communications, in accordance with the present disclosure.

FIG. 5 is a diagram illustrating an example of discrete Fourier transform spread orthogonal frequency division multiplexing (DFT-s-OFDM), in accordance with the present disclosure.

FIG. 6 is a diagram illustrating an example of DFT-s-OFDM and phase tracking reference signals (PT-RSs), in accordance with the present disclosure.

FIGS. 7A-7B are diagrams illustrating examples of PT-RSs and DFT-s-OFDM, in accordance with the present disclosure.

FIGS. 8-11 are diagrams illustrating examples associated with uplink resource muting and PT-RSs for DFT-s-OFDM waveforms, in accordance with the present disclosure.

FIG. 12 is a flowchart illustrating an example process performed, for example, by a user equipment (UE), in accordance with the present disclosure.

FIG. 13 is a flowchart illustrating an example process performed, for example, by a network node, in accordance with the present disclosure.

FIGS. 14-15 are diagrams of example apparatuses for wireless communication, in accordance with the present disclosure.

### SUMMARY

In some implementations, an apparatus for wireless communication at a user equipment (UE) includes one or more memories, and one or more processors, coupled to the one or more memories, configured to cause the UE to: receive a configuration associated with one or more of an uplink resource muting or a phase tracking reference signal (PT-RS) for a discrete Fourier transform (DFT) spread orthogonal frequency division multiplexing (OFDM) (DFT-s-OFDM) waveform; and transmit an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration.

In some implementations, an apparatus for wireless communication at a network node includes one or more memories; and one or more processors, coupled to the one or more memories, configured to cause the network node to: transmit a configuration associated with one or more of an uplink resource muting or a PT-RS for a DFT-s-OFDM waveform; and receive an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration.

In some implementations, a method of wireless communication performed by a UE includes receiving a configuration associated with one or more of an uplink resource muting or a PT-RS for a DFT-s-OFDM waveform; and transmitting an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration.

In some implementations, a method of wireless communication performed by a network node includes transmitting a configuration associated with one or more of an uplink resource muting or a PT-RS for a DFT-s-OFDM waveform; and receiving an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration.

In some implementations, a non-transitory computer-readable medium storing a set of instructions for wireless communication includes one or more instructions that, when executed by one or more processors of a UE, cause the UE to: receive a configuration associated with one or more of an uplink resource muting or a PT-RS for a DFT-s-OFDM waveform; and transmit an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration.

In some implementations, a non-transitory computer-readable medium storing a set of instructions for wireless communication includes one or more instructions that, when executed by one or more processors of a network node, cause the network node to: transmit a configuration associated with one or more of an uplink resource muting or a PT-RS for a DFT-s-OFDM waveform; and receive an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration.

In some implementations, an apparatus for wireless communication includes means for receiving a configuration associated with one or more of an uplink resource muting or a PT-RS for a DFT-s-OFDM waveform; and means for transmitting an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration.

In some implementations, an apparatus for wireless communication includes means for transmitting a configuration associated with one or more of an uplink resource muting or a PT-RS for a DFT-s-OFDM waveform; and means for receiving an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A full duplex (FD) operation may involve an in-band full duplex (IBFD) operation, in which a transmission and a reception may occur on the same time and frequency resource. A downlink direction and an uplink direction may share the same IBFD time/frequency resource based at least in part on a full or partial overlap. Alternatively, the FD operation may involve a subband full duplex (SBFD) operation (or flexible duplex), in which a transmission and a reception may occur at the same time but on different frequency resources. A downlink resource may be separated from an uplink resource in a frequency domain. In the SBFD operation, no downlink and uplink overlap in frequency may occur.

An SBFD operation may increase an uplink duty cycle, which may result in a latency reduction (e.g., a downlink signal may be received in uplink-only slots, which may enable latency savings) and uplink coverage improvement. The SBFD operation may improve a system capacity, resource utilization, and/or spectrum efficiency. The SBFD operation may enable a flexible and dynamic uplink/downlink resource adaption according to uplink/downlink traffic in a robust manner.

When the SBFD operation is employed, in some cases, cross-link interference (CLI) may occur between user equipments (UEs) and/or between network nodes. A CLI handling enhancement may involve an uplink resource muting for an uplink channel. The uplink resource muting may be for a CLI measurement. Network nodes may use the CLI measurement to mitigate the CLI.

A discrete Fourier transform (DFT) spread orthogonal frequency division multiplexing (OFDM) (DFT-s-OFDM) waveform generation may overlap with the uplink resource muting, and in this case, the DFT-s-OFDM waveform generation may not define various aspects when used in conjunction with the uplink resource muting. For example, the DFT-s-OFDM waveform generation may not define a mapping of information symbols via a DFT transform when the uplink resource muting is active. The DFT-s-OFDM waveform generation may not define a total number of information symbols that are allowed to be transmitted with respect to OFDM symbols with uplink resource muting. The DFT-s-OFDM waveform generation may not define a transform precoding for OFDM symbols with uplink resource muting. The DFT-s-OFDM waveform generation may not define a phase tracking reference signal (PT-RS) assignment for OFDM symbols with uplink resource muting. In other words, the DFT-s-OFDM waveform generation may not be able to properly handle PT-RSs. DFT-s-OFDM waveforms in SBFD may not be properly configured when the uplink resource muting is active, thereby degrading an overall system performance.

Various aspects relate generally to uplink resource muting. Some aspects more specifically relate to uplink resource muting and PT-RSs for DFT-s-OFDM waveforms. In some examples, a UE may receive, from a network node, a configuration associated with one or more of an uplink resource muting or a PT-RS for a DFT-s-OFDM waveform. The configuration may indicate that the uplink resource muting for the DFT-s-OFDM waveform is based at least in part on a DFT size and an input sequence that is generated based at least in part on repeated information symbols. The configuration may indicate that the uplink resource muting for the DFT-s-OFDM waveform is based at least in part on a half DFT size and a changed RE mapping. The UE may determine, based at least in part on the configuration, a total number of information symbols that are permitted to be transmitted as part of an uplink transmission when the uplink resource muting is configured for an uplink channel with the DFT-s-OFDM waveform. The UE may perform, based at least in part on the configuration, a transform precoding in accordance with the DFT-s-OFDM waveform. The UE may determine, based at least in part on a standard definition or a UE capability signaling, a PT-RS assignment of the one or more PT-RS symbols in the uplink transmission, where the PT-RS assignment may be for OFDM symbols with uplink resource muting. The UE may transmit, to the network node, the uplink transmission based at least in part on the configuration. The uplink transmission may be associated with the uplink resource muting, the one or more information symbols, and/or the one or more PT-RS symbols, where a mapping of the one or more information symbols and/or the one or more PT-RS symbols may be based at least in part on the configuration.

Particular aspects of the subject matter described in this disclosure can be implemented to realize one or more of the following potential advantages. In some examples, by configuring the UE to perform uplink transmissions with uplink resource muting for DFT-s-OFDM waveforms, the described techniques can be used to improve uplink resource muting for DFT-s-OFDM waveforms in SBFD. When a DFT-s-OFDM waveform generation overlaps with the uplink resource muting, the UE, based at least in part on the configuration, may support the DFT-s-OFDM waveform generation that defines a mapping of information symbols via a DFT transform when the uplink resource muting is active. The UE may support the DFT-s-OFDM waveform generation that defines the transform precoding for OFDM symbols with uplink resource muting. The UE may support the DFT-s-OFDM waveform generation that defines the PT-RS assignment for OFDM symbols with uplink resource muting. As a result, the UE may be configured to support DFT-s-OFDM waveforms in SBFD when the uplink resource muting is active, thereby improving an overall system performance.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

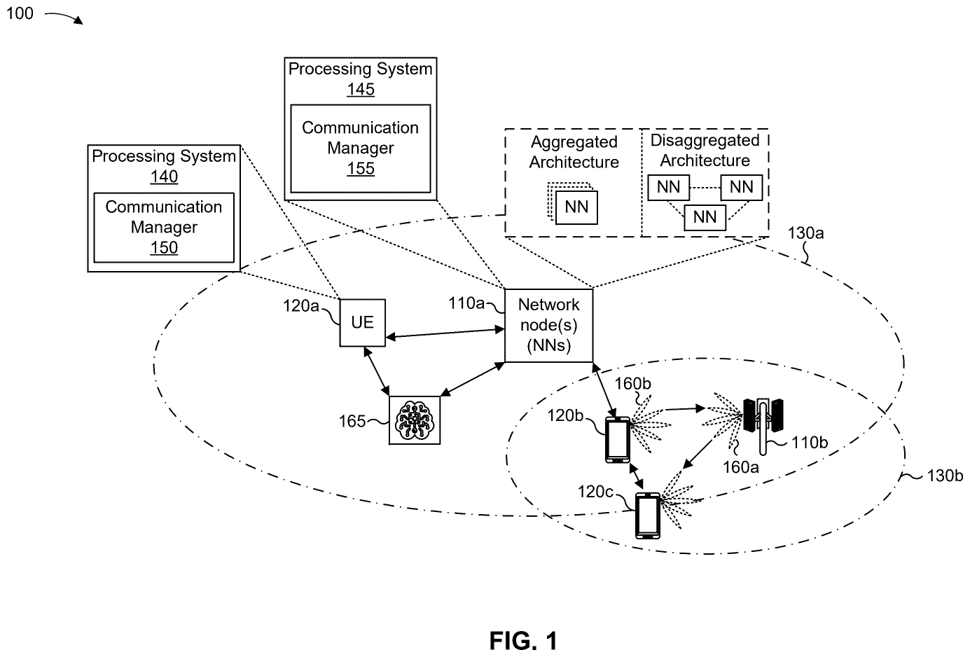

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

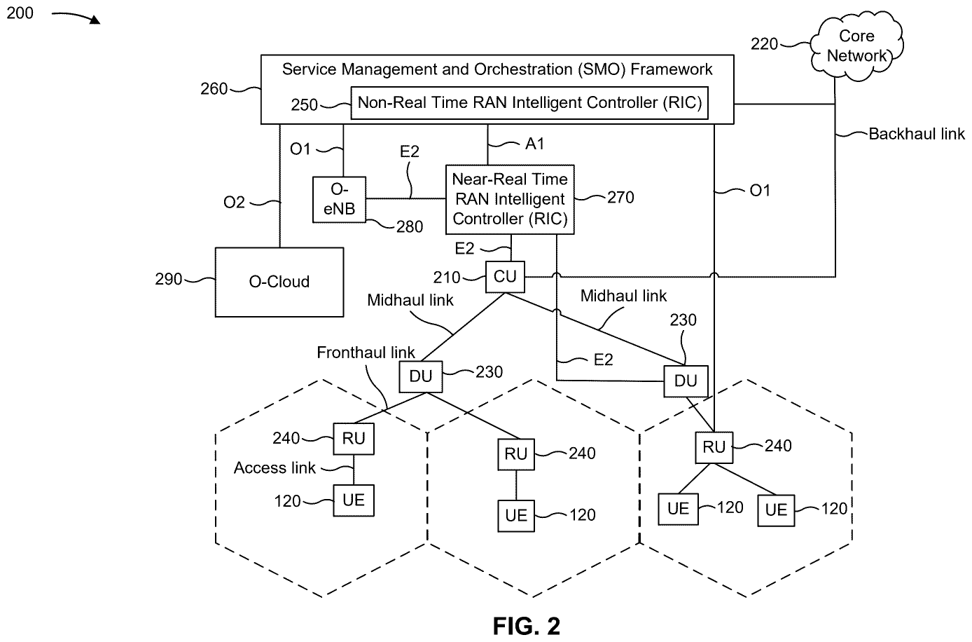

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks (RBs), and resource elements (REs)), and spatial domain resources (for example, particular transmit directions or beams).

Frequency domain resources may be subdivided into bandwidth parts (BWPs). A BWP may be a block of frequency domain resources (for example, a continuous set of RBs within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a PT-RS, a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PT-RS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a DFT-s-OFDM waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, a UE (e.g., the UE 120) may include a communication manager 150. As described in more detail elsewhere herein, the communication manager 150 may receive a configuration associated with one or more of an uplink resource muting or a PT-RS for a DFT-s-OFDM waveform; and transmit an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration. Additionally, or alternatively, the communication manager 150 may perform one or more other operations described herein.

In some aspects, a network node (e.g., the network node 110) may include a communication manager 155. As described in more detail elsewhere herein, the communication manager 155 may transmit a configuration associated with one or more of an uplink resource muting or a PT-RS for a DFT-s-OFDM waveform; and receive an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration. Additionally, or alternatively, the communication manager 155 may perform one or more other operations described herein.

As indicated above, FIG. 1 is provided as an example. Other examples may differ from what is described with regard to FIG. 1.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

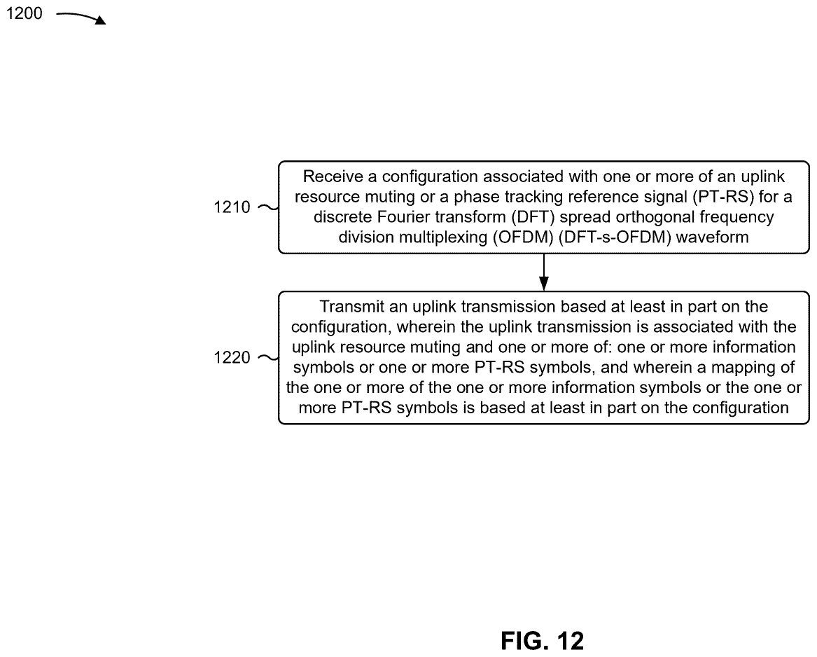

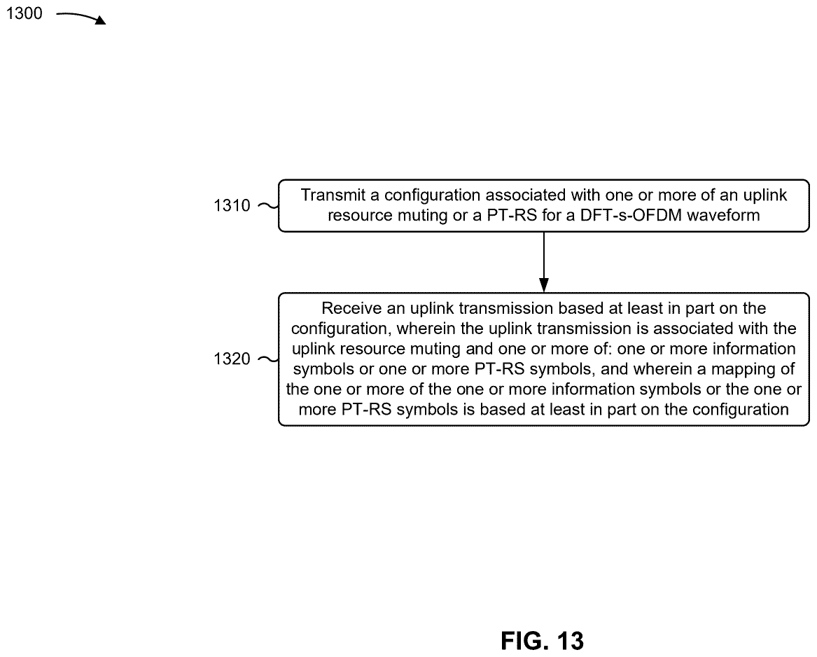

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with uplink resource muting and PT-RSs for DFT-s-OFDM waveforms, as described in more detail elsewhere herein. For example, the processing system 145 of the network node 110, the processing system 140 of the UE 120, the CU 210, the DU 230, or the RU 240 may perform or direct operations of, for example, process 1200 of FIG. 12, process 1300 of FIG. 13, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1200 of FIG. 12, process 1300 of FIG. 13, or other processes as described herein. In some examples, executing instructions may include running the instructions, converting the instructions, compiling the instructions, and/or interpreting the instructions, among other examples.

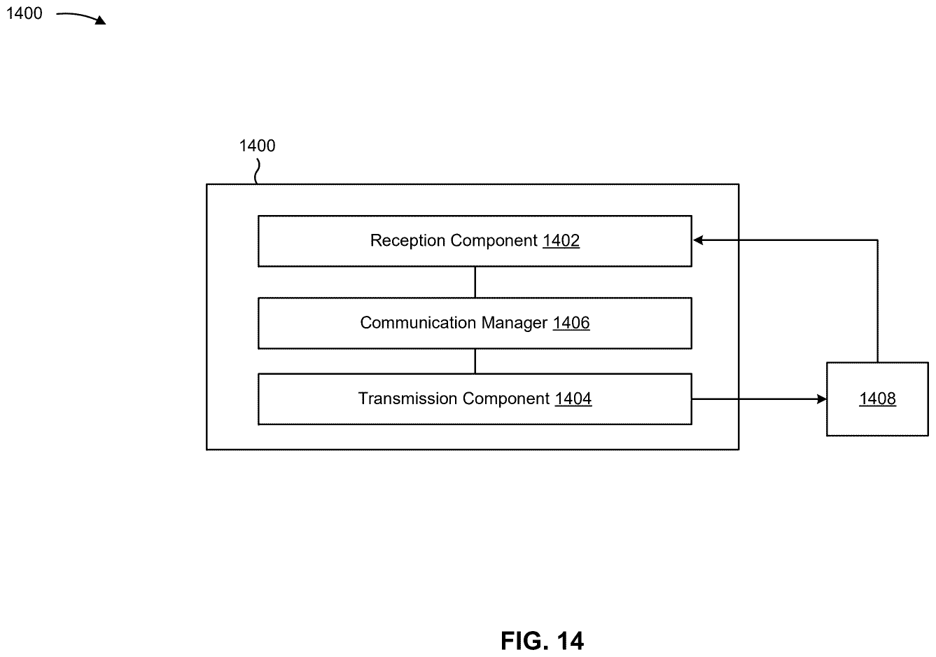

In some aspects, a UE (e.g., the UE 120) includes means for receiving a configuration associated with one or more of an uplink resource muting or a PT-RS for a DFT-s-OFDM waveform; and/or means for transmitting an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration. The means for the UE to perform operations described herein may include, for example, one or more of communication manager 150, processing system 140, a radio, one or more RF chains, one or more transceivers, one or more antennas, one or more modems, a reception component (for example, reception component 1402 depicted and described in connection with FIG. 14), and/or a transmission component (for example, transmission component 1404 depicted and described in connection with FIG. 14), among other examples.

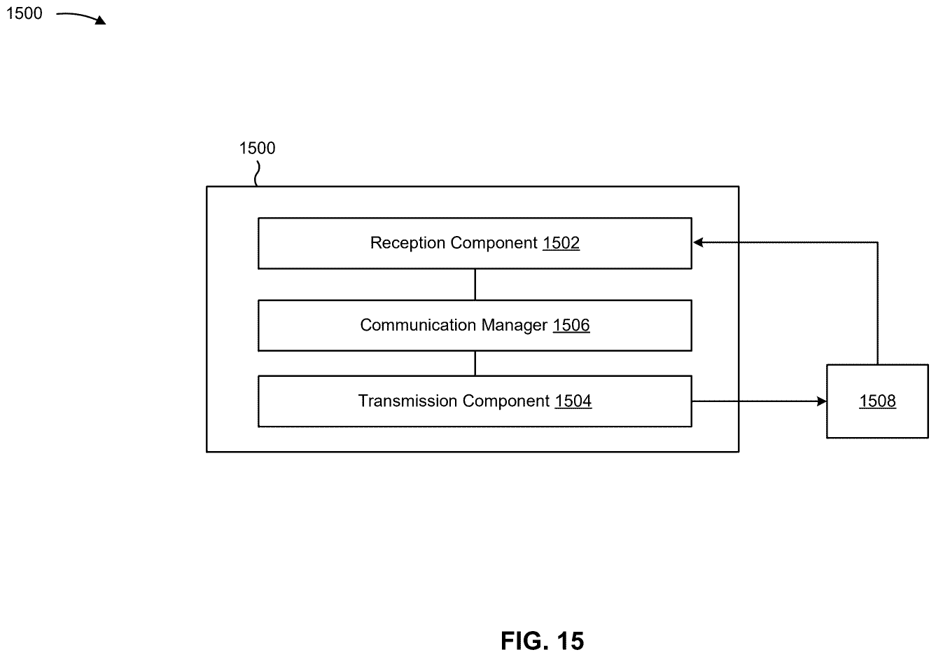

In some aspects, a network node (e.g., the network node 110) includes means for transmitting a configuration associated with one or more of an uplink resource muting or a PT-RS for a DFT-s-OFDM waveform; and/or means for receiving an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration. The means for the network node to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), and/or a transmission component (for example, transmission component 1504 depicted and described in connection with FIG. 15), among other examples.

As indicated above, FIG. 2 is provided as an example. Other examples may differ from what is described with regard to FIG. 2.

An FD operation may involve an IBFD operation, in which a transmission and a reception may occur on the same time and frequency resource. A downlink direction and an uplink direction may share the same IBFD time/frequency resource based at least in part on a full or partial overlap. Alternatively, the FD operation may involve an SBFD operation (or flexible duplex), in which a transmission and a reception may occur at the same time but on different frequency resources. A downlink resource may be separated from an uplink resource in a frequency domain. In the SBFD operation, no downlink and uplink overlap in frequency may occur.

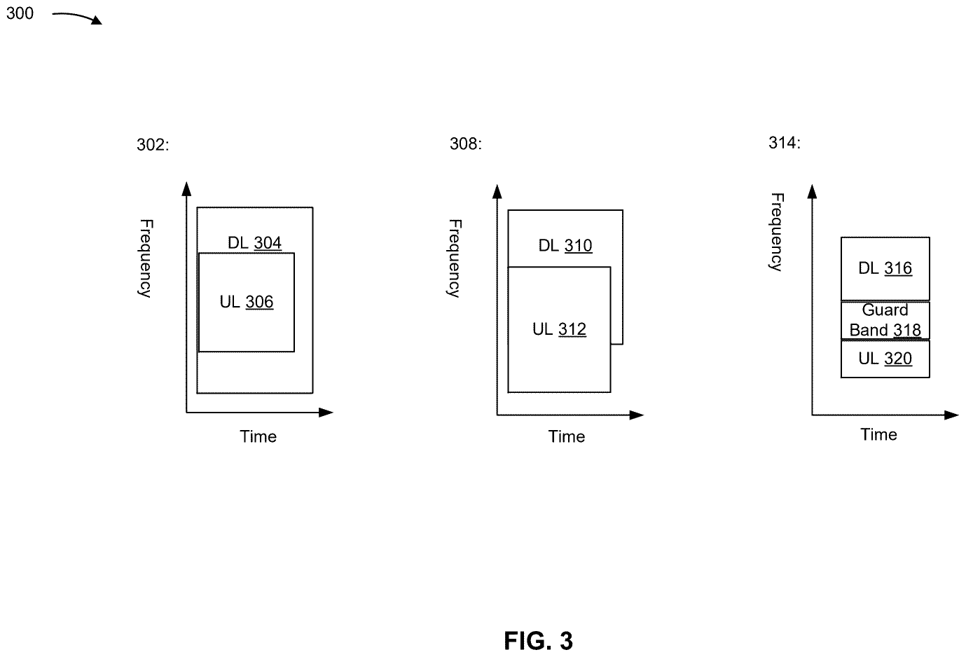

FIG. 3 is a diagram illustrating examples 300 of FD communications, in accordance with the present disclosure.

As shown by reference number 302, a downlink resource 304 and an uplink resource 306 may share the same IBFD time/frequency resource based at least in part on a full overlap. As shown by reference number 308, a downlink resource 310 and an uplink resource 312 may share the same IBFD time/frequency resource based at least in part on a partial overlap. As shown by reference number 314, a downlink resource 316 and an uplink resource 320 may be associated with a same time but different frequencies. The downlink resource 316 and the uplink resource 320 may be separated by a guard band 318.

As indicated above, FIG. 3 is provided as an example. Other examples may differ from what is described with regard to FIG. 3.

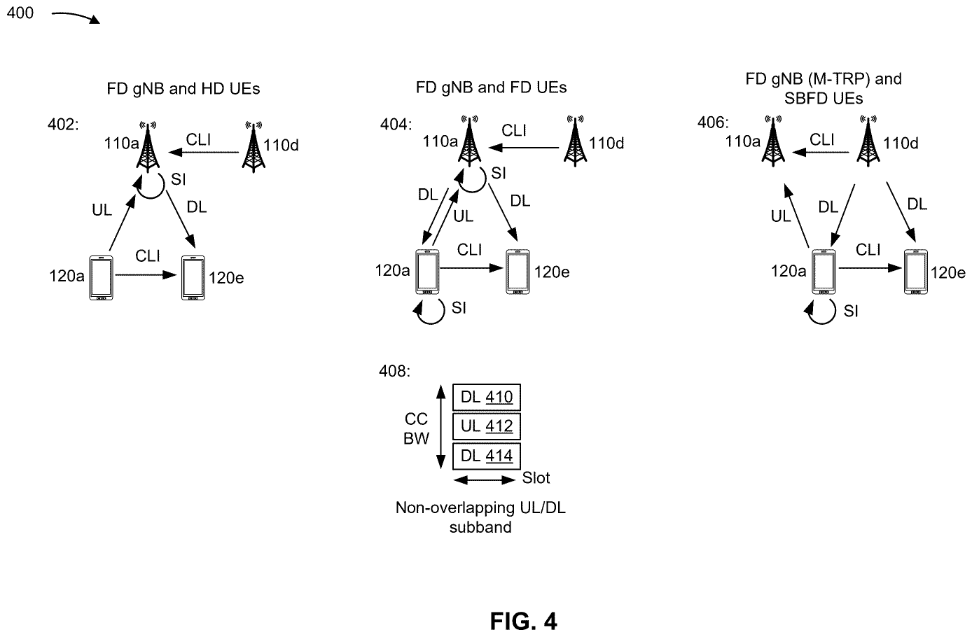

FIG. 4 is a diagram illustrating examples 400 of FD communications, in accordance with the present disclosure.

As shown by reference number 402, an FD network node (e.g., network node 110a) may communicate with half duplex (HD) UEs. The FD network node may be subjected to CLI from another FD network node (e.g., network node 110d). The CLI from the other FD network node may be inter-network node CLI. The FD network node may experience self-interference (SI). The FD network node may receive an uplink transmission from a first HD UE (e.g., UE 120a), and the FD network node may transmit a downlink transmission to a second HD UE (e.g., UE 120e). The FD network node may receive the uplink transmission and transmit the downlink transmission on the same slot (e.g., a simultaneous reception/transmission). The second HD UE may be subjected to CLI from the first HD UE (e.g., inter-UE CLI).

As shown by reference number 404, an FD network node (e.g., network node 110a) may communicate with FD UEs. The FD network node may be subjected to CLI from another FD network node (e.g., network node 110d). The FD network node may experience SI. The FD network node may transmit a downlink transmission to a first FD UE (e.g., UE 120a), and the FD network node may receive an uplink transmission from the first FD UE at the same time as the downlink transmission. The FD network node may transmit a downlink transmission to a second FD UE (e.g., UE 120e). The second HD UE may be subjected to CLI from the first HD UE. The first UE may experience SI.

As shown by reference number 406, a first FD network node (e.g., network node 110a), which may be associated with multiple transmission reception points (TRPs), may communicate with SBFD UEs. The first FD network node may be subjected to CLI from a second FD network node (e.g., network node 110a). The first FD network node may receive an uplink transmission from a first SBFD UE (e.g., UE 120a). The second FD network node may transmit downlink transmissions to both the first SBFD UE and a second SBFD UE (e.g., UE 120e). The second SBFD UE may be subjected to CLI from the first SBFD UE. The first SBFD UE may experience SI.

As shown by reference number 408, an SBFD slot may be associated with a non-overlapping uplink/downlink sub-band. The SBFD slot may be associated with a simultaneous transmission/reception of a downlink/uplink on a sub-band basis. Within a component carrier bandwidth, an uplink resource 412 may be in between, in a frequency domain, a first downlink resource 410 and a second downlink resource 414. The first downlink resource 410, the second downlink resource 414, and the uplink resource 412 may all be associated with the same time.

An SBFD operation may increase an uplink duty cycle, which may result in a latency reduction (e.g., a downlink signal may be received in uplink-only slots, which may enable latency savings) and uplink coverage improvement. The SBFD operation may improve a system capacity, resource utilization, and/or spectrum efficiency. The SBFD operation may enable a flexible and dynamic uplink/downlink resource adaption according to uplink/downlink traffic in a robust manner.

As indicated above, FIG. 4 is provided as an example. Other examples may differ from what is described with regard to FIG. 4.

A CLI handling enhancement may involve an uplink resource muting for a PUSCH. The uplink resource muting may be for a CLI measurement. An indication or determination of the uplink resource muting for the PUSCH may be based at least in part on a semi-static configuration, assuming comb-2 (e.g., every other RE in a frequency domain is a muted uplink resource) for both DFT-S-OFDM and CP-OFDM in each allocated physical resource block (PRB) and up to two symbols in a time domain (e.g., no new DCI field or MAC-CE). The uplink resource muting for the PUSCH may involve a PUSCH resource mapping (e.g., rate matching around muted REs). The uplink resource muting for the PUSCH may involve a UCI resource determination in symbols with muted REs (e.g., no impact on data and control multiplexing). The uplink resource muting for the PUSCH may not apply for a message A (Msg A) PUSCH and a message 3 (Msg 3) PUSCH. The uplink resource muting for the PUSCH may apply for only UEs in an RRC connected mode. The uplink resource muting for the PUSCH may be associated with an uplink resource muting pattern. The uplink resource muting pattern may be assumed to not overlap an uplink DMRS or a PT-RS in a same symbol. Power boosting may be assumed for REs in a symbol with uplink resource muting. A PUSCH transmit power may not change across symbols. The uplink resource muting may involve a transport block size (TBS) determination for the PUSCH. The uplink resource muting may or may not have any impact on a transmit signal quality or a maximum power reduction (MPR) requirement. The uplink resource muting for the PUSCH may be subject to a UE capability.

For a time location configuration of the uplink resource muting for the PUSCH, a first option may involve semi-statically configuring a position for each of up to two uplink muting symbols within a slot, or a second option may involve semi-statically configuring X (X≥1) possible positions for each of the up to two uplink muting symbols within the slot. The first option and the second option may have no implication on an uplink muting symbol indication/determination. The first option and the second option may involve up to two uplink muting symbols for the PUSCH.

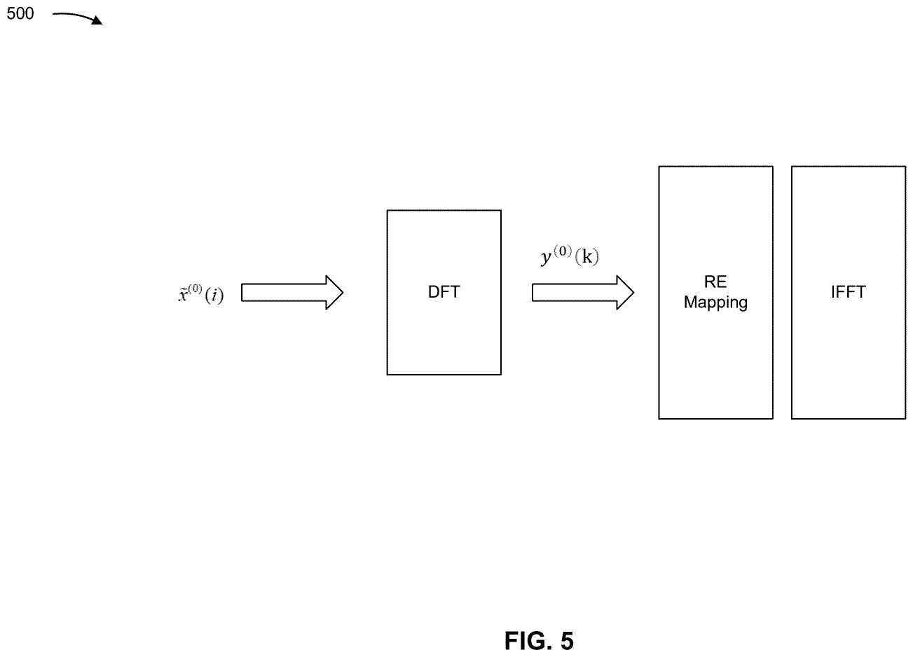

FIG. 5 is a diagram 500 illustrating an example of DFT-s-OFDM, in accordance with the present disclosure.

As shown in FIG. 5, for DFT-s-OFDM, a time-based sequence \tilde{x}⁽⁰⁾(i) may be provided to a DFT, which may produce a frequency-based sequence y⁽⁰⁾(k), which may then be used for an RE mapping and an inverse fast Fourier transform (IFFT). The DFT may be associated with a transform precoding. The transform precoding may be applied in accordance with:

$${y}^{( 0 )} ( l \cdot {M}_{sc}^{PUSCH} + k ) = \frac{1}{\sqrt{{M}_{sc}^{PUSCH}}} {\sum }_{i = 0}^{{M}_{sc}^{PUSCH} - 1} {\tilde{x}}^{( 0 )} ( l \cdot {M}_{sc}^{PUSCH} + i ) {e}^{- j \frac{2 π ik}{{M}_{sc}^{PUSCH}}}$$

$$k = 0 , ... , {M}_{sc}^{PUSCH} - 1$$

$$l = 0 , ... , {M}_{symb}^{layer} / {M}_{sc}^{PUSCH} - 1 ,$$

which may result in a block of complex-valued symbols

$${y}^{( 0 )} ( 0 ) , ... , {y}^{( 0 )} ( {M}_{symb}^{layer} - 1 ) .$$

For the transform precoding, l is an OFDM symbol index relative to a reference,

$${M}_{sc}^{PUSCH}$$

is a scheduled bandwidth for an uplink transmission (expressed as a number of subcarriers), k is a subcarrier index relative to a reference, and

$${M}_{symb}^{layer}$$

is a number of modulation symbols to transmit per layer for a physical channel. Further,

$${M}_{sc}^{PUSCH} = {M}_{RB}^{PUSCH} \cdot {N}_{sc}^{RB} , where {M}_{RB}^{PUSCH}$$

represents a bandwidth of a PUSCH in terms of RBs and

$${N}_{sc}^{RB}$$

represents a number of subcarriers per RB, and may fulfill:

$${M}_{RB}^{PUSCH} = {2}^{{α}_{2}} \cdot {3}^{{α}_{3}} \cdot {5}^{{α}_{5}} ,$$

where α₂, α₃, α₅ is a set of non-negative integers.

As indicated above, FIG. 5 is provided as an example. Other examples may differ from what is described with regard to FIG. 5.

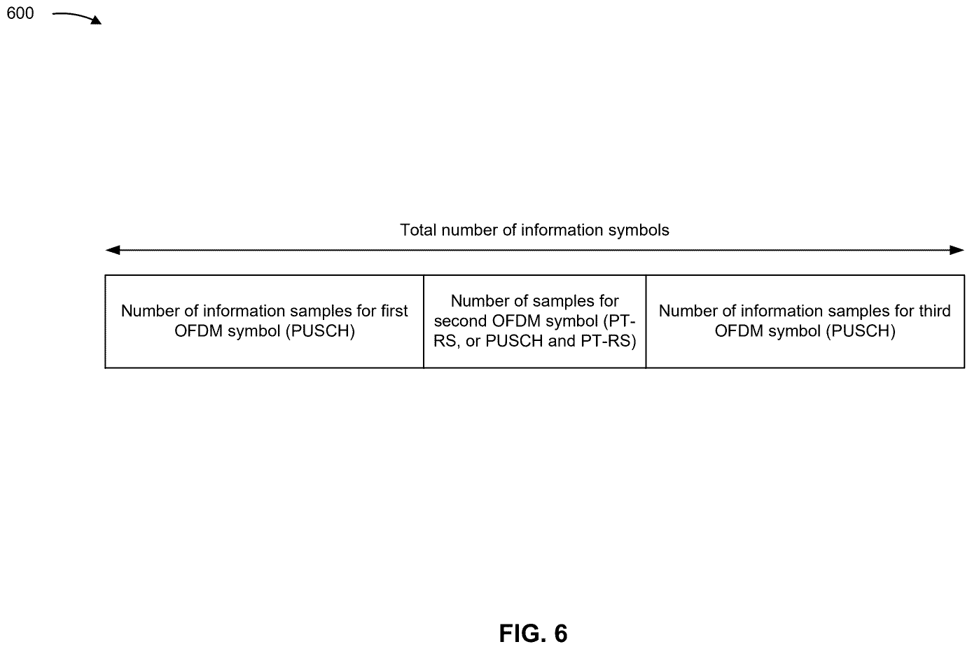

FIG. 6 is a diagram illustrating an example 600 of DFT-s-OFDM and PT-RSs, in accordance with the present disclosure.

When PT-RSs are not being used, a block of complex-valued symbols

$${x}^{( 0 )} ( 0 ) , ... , {x}^{( 0 )} ( {M}_{symb}^{layer} - 1 )$$

for a single layer λ=0 may be divided into

$${M}_{symb}^{layer} / {M}_{sc}^{PUSCH}$$

sets, each corresponding to one OFDM symbol and \tilde{x}⁽⁰⁾(i)=x⁽⁰⁾(i). When PT-RSs are being used, a block of complex-valued symbols

$${x}^{( 0 )} ( 0 ) , … , {x}^{( 0 )} ( {M}_{s y m b}^{layer} - 1 )$$

may be divided into sets, where each set may correspond to one OFDM symbol, and where set l may contain

$${M}_{sc}^{PUSCH} - {ε}_{l} {N}_{samp}^{group} {N}_{group}^{PTRS}$$

symbols and may be mapped to complex-valued symbols

$${\tilde{x}}^{( 0 )} ( l {M}_{s c}^{PUSCH} + {i}^{′} )$$

corresponding to OFDM symbol l prior to a transform precoding, with

$${i}^{′} ∈ \{ 0 , 1 , … , {M}_{sc}^{PUSCH} - 1 \}$$

and i′≠m. An index m of PT-RS samples in set l, a number of samples per PT-RS group

$${N}_{samp}^{group} ,$$

and a number of PT-RS groups

$${N}_{group}^{PT - RS}$$

may be defined. A quantity εₗ=1 when OFDM symbol l contains one or more PT-RS samples, otherwise εₗ=0. In this example,

$${N}_{samp}^{group}$$

is a number of samples per PT-RS group, and

$${N}_{group}^{PTRS}$$

is a number of PT-RS groups.

As shown in FIG. 6, for a total number of information symbols, a first

$${M}_{sc}^{PUSCH}$$

may correspond to a number of information samples for a first OFDM symbol (e.g., PUSCH),

$${M}_{sc}^{PT - RS}$$

may correspond to a number of PT-RS samples for a second OFDM symbol (e.g., PT-RS), and a second

$${M}_{sc}^{PUSCH}$$

may correspond to a number of information samples for a third OFDM symbol (e.g., PUSCH). In this example,

$${M}_{s c}^{PUSCH}$$

may not be uniform over the information symbols when a PT-RS is configured in some of the OFDM symbols. The PT-RS may be used for estimating a phase noise. The PT-RS may be inserted into a time domain pre-DFT (before transform precoding). In one example, the second OFDM symbol may be associated with a PT-RS, or the second OFDM symbol may be associated with a PUSCH and a PT-RS.

As indicated above, FIG. 6 is provided as an example. Other examples may differ from what is described with regard to FIG. 6.

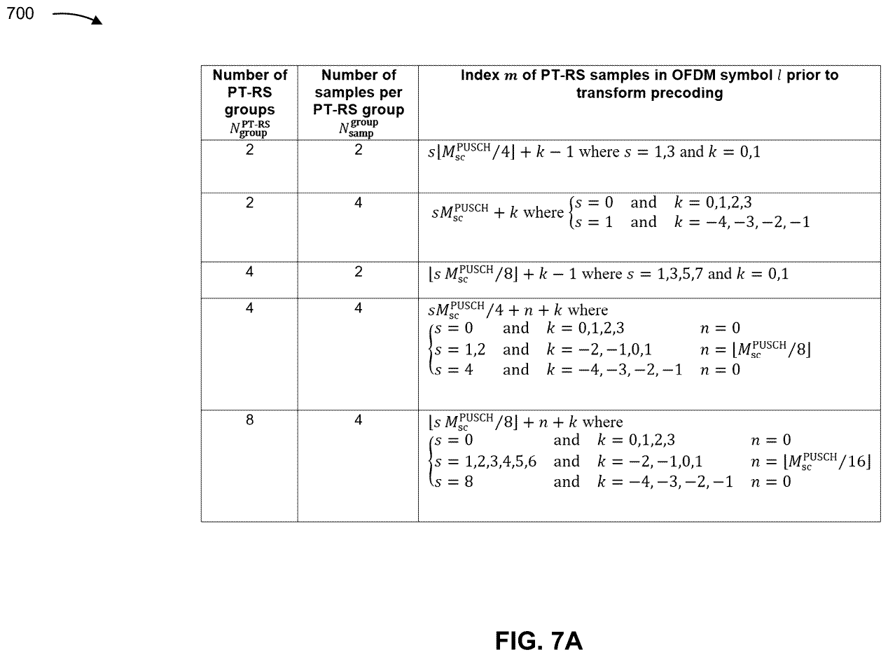

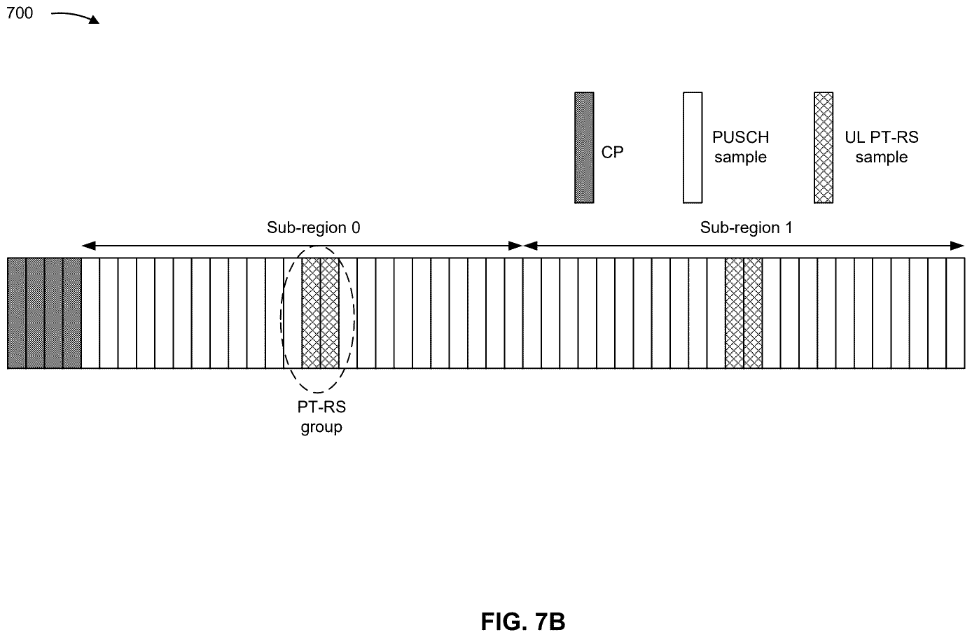

FIGS. 7A-7B are diagrams illustrating examples 700 of PT-RSs and DFT-s-OFDM, in accordance with the present disclosure.

An uplink PT-RS for a DFT-s-OFDM waveform may be supported. A possible PT-RS presence or absence may be configured via an uplink PT-RS present transform precoding (UL-PTRS-present-transform-precoding) RRC parameter. Multiple patterns or densities of a PT-RS for DFT-s-OFDM may be supported. A pre-DFT PT-RS insertion for uplink DFT-S-OFDM may be in the form of multiple chunks per symbol, where a supported number of chunks per DFT-S-OFDM symbol may be 2, 4, and 8. The supported number of chunks per DFT-S-OFDM symbol may implicitly depend on an allocated bandwidth. A time domain PT-RS density may be configured via an uplink PT-RS time density transform precoding (UL-PTRS-time-density-transform-precoding) RRC parameter, where supported time densities may be {1, 2}. The time domain PT-RS density may be based at least in part on every PUSCH carrying symbol or every other PUSCH carrying symbol.

As shown in FIG. 7A, in a PT-RS symbol mapping, a number of PT-RS groups

$$( {N}_{group}^{PT - RS} )$$

may be 2, 4, or 8, and a number of samples per PT-RS group

$$( {N}_{samp}^{group} )$$

may be 2 or 4. For each combination of

$${N}_{group}^{PT - RS} and {N}_{samp}^{group} ,$$

an index m of PT-RS samples in OFDM symbol l prior to a transform precoding may be defined. The PT-RS symbol mapping may be used to determine which samples in a time domain are to be used for a PT-RS (e.g., PT-RS density).

As shown in FIG. 7B, an OFDM symbol may include two sub-regions, which may include a first sub-region (sub-region 0) and a second sub-region (sub-region 1). The first sub-region may correspond to a first half of the OFDM symbol, and the second sub-region may correspond to a second half of the OFDM symbol. The OFDM symbol may include a cyclic prefix (CP). The first sub-region and the second sub-region may each include one PT-RS group. Each PT-RS group may include two samples. In this example,

$${N}_{group}^{P T - R S} = 2 and {N}_{samp}^{group} = 2 .$$

As indicated above, FIGS. 7A-7B are provided as examples. Other examples may differ from what is described with regard to FIGS. 7A-7B.

A number of PT-RS groups

$$( {N}_{group}^{P T - R S} )$$

may be determined using a UE PT-RS transmission procedure when a transform precoding is enabled. When the transform precoding is enabled and when a UE is configured with a transform precoder enabled (transformPrecoderEnabled) higher layer parameter in a PT-RS uplink configuration (PTRS-UplinkConfig), the UE may be configured with a sample density (sampleDensity) higher layer parameter and the UE may assume that a presence of one or more PT-RS antenna ports and a PT-RS group pattern are a function of a corresponding scheduled bandwidth in a corresponding BWP. The UE may assume that no PT-RS is present when a number of scheduled RBs is less than a sample density threshold N_{RB0} when N_{RB0}>1 or when a radio network temporary identifier (RNTI) is equal to a temporary cell RNTI (TC-RNTI). The UE may be configured with a PT-RS time density L_{PT-RS}=2 with a time density transform precoding (timeDensityTransformPrecoding) higher layer parameter. Otherwise, the UE may assume that L_{PT-RS}=1. When the sample density higher layer parameter indicates that sample density thresholds N_{RB,i}=N_{RB,i+1}, then an associated row where both of those thresholds appear may be disabled.

A PT-RS group pattern may be a function of a scheduled bandwidth (N_{RB}). When the scheduled bandwidth is greater than or equal to a first threshold (N_{RB0}) and less than a second threshold (N_{RB1}) (N_{RB0}≤N_{RB}<N_{RB1}), a number of PT-RS groups is 2 and a number of samples per PT-RS group is 2. When the scheduled bandwidth is greater than or equal to the second threshold and less than a third threshold (N_{RB2}) (N_{RB1}≤N_{RB}<N_{RB2}), a number of PT-RS groups is 2 and a number of samples per PT-RS group is 4. When the scheduled bandwidth is greater than or equal to the third threshold and less than a fourth threshold (N_{RB3}) (N_{RB2}≤N_{RB}<N_{RB3}), a number of PT-RS groups is 4 and a number of samples per PT-RS group is 2. When the scheduled bandwidth is greater than or equal to the fourth threshold and less than a fifth threshold (N_{RB4}) (N_{RB3}≤N_{RB}<N_{RB4}), a number of PT-RS groups is 4 and a number of samples per PT-RS group is 4. When the scheduled bandwidth is greater than or equal to the fifth threshold (N_{RB4}≤N_{RB}), a number of PT-RS groups is 8 and a number of samples per PT-RS group is 4.

The PT-RS uplink configuration may include a transform precoder disabled configuration, which may be a configuration of an uplink PT-RS without a transform precoder (e.g., CP-OFDM). The transform precoder disabled configuration may include a frequency density, a time density, a maximum number of ports, an RE offset, and a PT-RS power. The frequency density may indicate a presence and frequency density of the uplink PT-RS for a CP-OFDM waveform as a function of a scheduled bandwidth. The time density may indicate a presence and time density of the uplink PT-RS for the CP-OFDM waveform as a function of an MCS. The maximum number of ports may indicate a maximum number of uplink PT-RS ports for CP-OFDM. The RE offset may indicate a subcarrier offset for the uplink PT-RS for CP-OFDM. The PT-RS power may indicate an uplink PT-RS power boosting factor per PT-RS port. The PT-RS uplink configuration may include a transform precoder enabled configuration, which may be a configuration of an uplink PT-RS with a transform precoder (e.g., DFT-s-OFDM). The transform precoder enabled configuration may include a sample density and a time density transform precoding. The sample density may be of a PT-RS for DFT-s-OFDM, pre-DFT, indicating a set of thresholds. The set of thresholds may indicate a dependency between a presence of the uplink PT-RS and a scheduled bandwidth. The sample density may indicate values of

$${N}_{group}^{PTRS} and {N}_{samp}^{group}$$

that the UE should use depending on the scheduled bandwidth. The time density transform precoding may indicate a time density (OFDM symbol level) of the PT-RS for DFT-s-OFDM.

A sequence generation may be performed when the transform precoding is enabled. When the transform precoding is enabled, a PT-RS rₘ(m′) may be mapped in position m before the transform precoding, where m depends on a number of PT-RS groups

$${N}_{group}^{P T - R S} ,$$

a number of samples per PT-RS group

$${N}_{samp}^{group} , and {M}_{sc}^{PUSCH} .$$

The PT-RS rₘ(m′) that is mapped may be generated in accordance with:

$${r}_{m} ( {m}^{′} ) = w ( {k}^{′} ) \frac{{e}^{j \frac{π}{2} ( m mod 2 )}}{\sqrt{2}} [ ( 1 - 2 c ( {m}^{′} ) ) + j ( 1 - 2 c ( {m}^{′} ) ) ] \\ {m}^{′} = {N}_{samp}^{{group}_{{S}^{′}}} + k \\ {s}^{′} = 0 , 1 , … , {N}_{group}^{PT - RS} - 1 \\ {k}^{′} = 0 , L , … , {N}_{samp}^{group} - 1 ,$$

where pseudo-random sequences c(i) and w(i) may be defined. A pseudo-random sequence generator may be initialized with:

$${c}_{init} = ( {2}^{17} ( {N}_{symb}^{slot} {n}_{s , f}^{μ} + l + 1 ) ( 2 {N}_{ID} + 1 ) + 2 {N}_{ID} ) mod {2}^{31} ,$$

where l is a lowest OFDM symbol number in a PUSCH allocation in slot

$${n}_{s , f}^{μ}$$

that contains a PT-RS and N_{ID} is given by a PUSCH identity (nPUSCH-Identity) higher layer parameter.

A DFT-s-OFDM waveform generation may overlap with an uplink resource muting, and in this case, the DFT-s-OFDM waveform generation may not define various aspects when used in conjunction with the uplink resource muting. For example, the DFT-s-OFDM waveform generation may not define a mapping of information symbols via a DFT transform when the uplink resource muting is active. The DFT-s-OFDM waveform generation may not define a total number of information symbols that are allowed to be transmitted with respect to OFDM symbols with uplink resource muting. The DFT-s-OFDM waveform generation may not define a transform precoding for OFDM symbols with uplink resource muting. The DFT-s-OFDM waveform generation may not define a PT-RS assignment for OFDM symbols with uplink resource muting. In other words, the DFT-s-OFDM waveform generation may not be able to properly handle PT-RSs. DFT-s-OFDM waveforms in SBFD may not be properly configured when the uplink resource muting is active, thereby degrading an overall system performance.

In various aspects of techniques and apparatuses described herein, a UE may receive, from a network node, a configuration associated with one or more of an uplink resource muting or a PT-RS for a DFT-s-OFDM waveform. The configuration may indicate that the uplink resource muting for the DFT-s-OFDM waveform is based at least in part on a DFT size and an input sequence that is generated based at least in part on repeated information symbols. The configuration may indicate that the uplink resource muting for the DFT-s-OFDM waveform is based at least in part on a half DFT size and a changed RE mapping. The UE may determine, based at least in part on the configuration, a total number of information symbols that are permitted to be transmitted as part of an uplink transmission when the uplink resource muting is configured for an uplink channel with the DFT-s-OFDM waveform. The UE may perform, based at least in part on the configuration, a transform precoding in accordance with the DFT-s-OFDM waveform. The UE may determine, based at least in part on a standard definition or a UE capability signaling, a PT-RS assignment of the one or more PT-RS symbols in the uplink transmission, where the PT-RS assignment may be for OFDM symbols with uplink resource muting. The UE may transmit, to the network node, the uplink transmission based at least in part on the configuration. The uplink transmission may be associated with the uplink resource muting, the one or more information symbols, and/or the one or more PT-RS symbols, where a mapping of the one or more information symbols and/or the one or more PT-RS symbols may be based at least in part on the configuration.

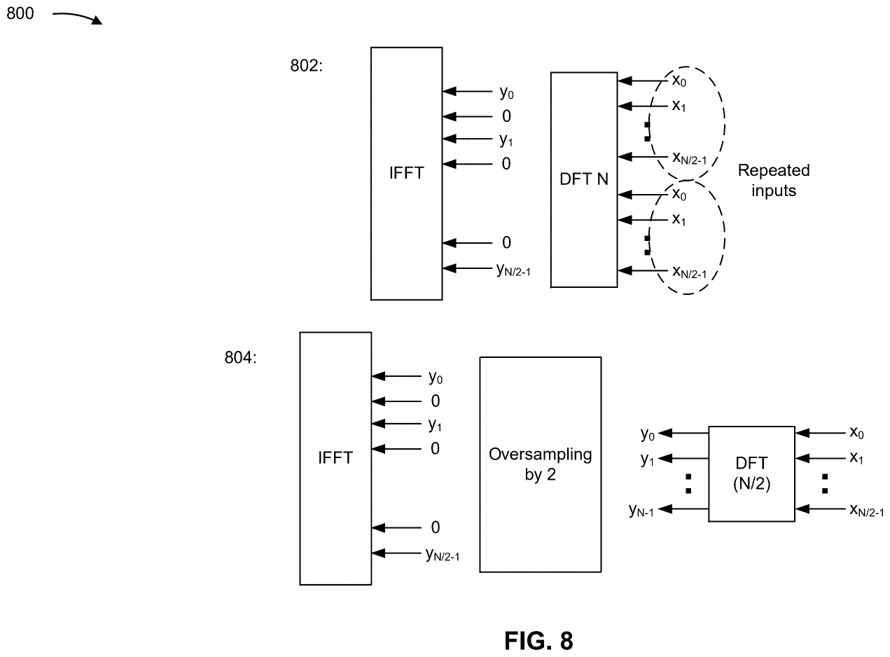

FIG. 8 is a diagram illustrating an example 800 associated with uplink resource muting and PT-RSs for DFT-s-OFDM waveforms, in accordance with the present disclosure.

As shown by reference number 802, when defining an uplink resource muting for DFT-s-OFDM, a same DFT size may be applied and an input signal may be manipulated in time pre-DFT to create an uplink resource muting pattern. The input signal, such as a sequence X₀ to X_{N/2-1}, may be repeated, and after a DFT (e.g., DFT N, where N is a DFT size), a sequence Y₀ to Y_{N/2-1} may be obtained. The sequence Y₀ to Y_{N/2-1} may then undergo an IFFT. In this example, for the uplink resource muting in DFT-s-OFDM, the same DFT size may be kept and the input signal may be repeated in time. Repeating information symbols X in a time domain (time domain sequence) may be equivalent to comb-2 with an RE offset equal to 0. In other words, repeating the information symbols X in the time domain may correspond to DFT ([X X]), where X is an information sequence (complex-valued symbols) of size

$$\frac{{M}_{sc}^{PUSCH}}{2} .$$

When the RE offset is equal to 1, in a first option, the time domain sequence may be multiplied with a phase ramp. The time domain sequence [X X] may be multiplied with a phase ramp exp(j×2×π×(0:M−1)/M), where M is a DFT size. When the RE offset is equal to 1, in a second option, a circular shift may be applied in a frequency domain after the DFT.

As shown by reference number 804, when defining an uplink resource muting for DFT-s-OFDM, a smaller DFT size, in relation to a previous DFT size, may be applied, and an input signal may be manipulated in a frequency domain to create an uplink resource muting pattern. The input signal, such as a sequence X₀ to X_{N/2-1}, may be used, and after a half DFT (e.g., DFT (N/2)), a sequence Y₀ to Y_{N-1} may be obtained. The sequence Y₀ to Y_{N-1} may be oversampled by 2 to produce a sequence Y₀ to Y_{N/2-1}, which may then undergo an IFFT. In this example, for the uplink resource muting in DFT-s-OFDM, half of the DFT size may be used and an RE mapping may be changed based at least in part on a comb-2 uplink resource muting pattern. Muted REs associated with the uplink resource muting pattern, post-DFT, may be unsampled REs or REs associated with inserted zeros.

As indicated above, FIG. 8 is provided as an example. Other examples may differ from what is described with regard to FIG. 8.

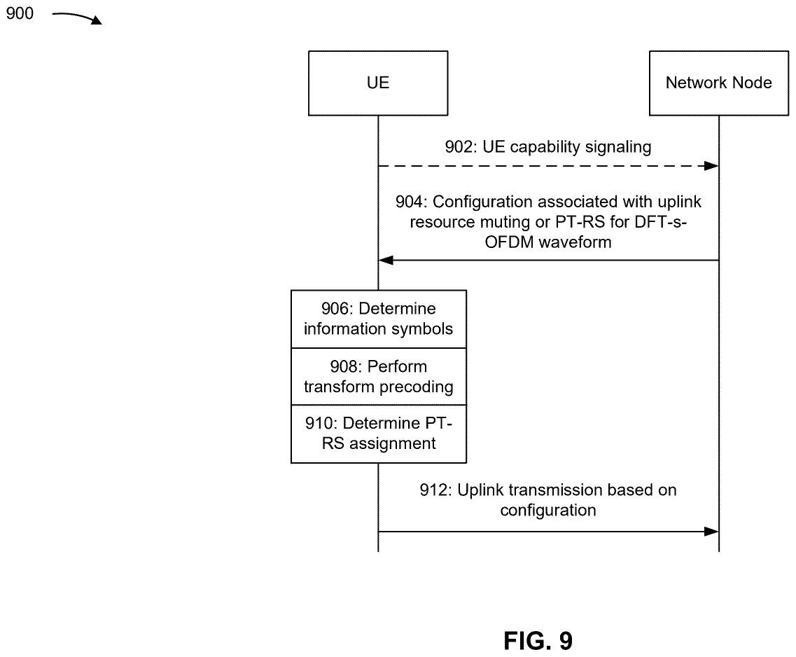

FIG. 9 is a diagram illustrating an example 900 associated with uplink resource muting and PT-RSs for DFT-s-OFDM waveforms, in accordance with the present disclosure. As shown in FIG. 9, example 900 includes communication between a UE (e.g., UE 120) and a network node (e.g., network node 110). In some aspects, the UE and the network node may be included in a wireless network, such as wireless network 100.

As shown by reference number 902, the UE may transmit, to the network node, a UE capability report, wherein the configuration is received based at least in part on the UE capability report. The UE capability report may indicate a capability of the UE regarding an uplink resource muting for a DFT-s-OFDM waveform, where the uplink resource muting may or may not be associated with a PT-RS. The UE capability report may indicate that the UE supports a first implementation or a second implementation for the uplink resource muting. In the first implementation, an input signal with a same DFT size may be used (e.g., as shown by reference number 802 in FIG. 8). In the second implementation, an input signal with a smaller DFT size may be used (e.g., as shown by reference number 804 in FIG. 8).

As shown by reference number 904, the UE may receive, from the network node, a configuration associated with one or more of the uplink resource muting or the PT-RS for the DFT-s-OFDM waveform. The configuration may be based at least in part on the UE capability report. The configuration may indicate that the uplink resource muting for the DFT-s-OFDM waveform is based at least in part on the DFT size and the input sequence that is generated based at least in part on repeated information symbols. Alternatively, the configuration may indicate that the uplink resource muting for the DFT-s-OFDM waveform is based at least in part on a half DFT size (e.g., the smaller DFT size) and a changed RE mapping. The configuration may indicate one or more parameters, which may be used by the UE for determining a total number of information bits that are able to be transmitted, performing a transform precoding, and/or determining a PT-RS assignment. The one or more parameters may be for when the PT-RS is transmitted in OFDM symbols associated with the uplink resource muting or for when the PT-RS is not transmitted in OFDM symbols associated with the uplink resource muting.

As shown by reference number 906, the UE may determine, based at least in part on the configuration, the total number of information symbols that are permitted to be transmitted as part of an uplink transmission when the uplink resource muting is configured for a PUSCH with the DFT-s-OFDM waveform. In some aspects, the PT-RS may not be transmitted in an uplink direction. The total number of information bits may be based at least in part on a number of OFDM symbols with the uplink resource muting, a number of PUSCH symbols, and a scheduled bandwidth for the uplink transmission. A block of complex-valued symbols may be divided into sets, where each set may be mapped to one OFDM symbol. In some aspects, the PT-RS may be transmitted in the uplink direction. The total number of information bits may be based at least in part on a number of symbols with the PT-RS, a number of PT-RS groups, and a number of PT-RS samples per PT-RS group.

In some aspects, when the uplink resource muting is configured or enabled for a PUSCH with the transform precoding enabled, such as in DFT-s-OFDM, the total number of information bits (M′) that are able to be transmitted by the UE, without the PT-RS, may be calculated in accordance with:

$${M}^{′} = ( L - x ) * {M}_{sc}^{PUSCH} + x * \frac{{M}_{sc}^{PUSCH}}{2} ,$$

where x=0, 1, or 2 is a number of OFDM symbols with uplink resource muting, and L is a number of uplink shared channel (UL-SCH) symbols (e.g., a number of PUSCH symbols). A block of complex-valued symbols may be divided into sets of complex-valued symbols, where each set may be mapped to one OFDM symbol, and a size of each set may be defined.

In some aspects, when PT-RSs are not being used, a block of complex-valued symbols x⁽⁰⁾(0), . . . ,

$${x}^{( 0 )} ( {M}_{symb}^{layer} - 1 )$$

for a single layer λ=0 may be divided into sets, each corresponding to one OFDM symbol, where set ‘l’ contains

$${M}_{sc}^{PUSCH} - {δ}_{l} \frac{{M}_{sc}^{PUSCH}}{2}$$

where δₗ=1 when OFDM symbol ‘l’ contains an uplink resource muting pattern, and δₗ=0 otherwise. For symbol ‘l’,

$${M}_{sc , l}^{PUSCH} = {M}_{sc}^{PUSCH} - {δ}_{l} \frac{{M}_{sc}^{PUSCH}}{2} .$$

In some aspects, when the uplink resource muting is configured or enabled for the PUSCH with the transform precoder enabled, such as in DFT-s-OFDM, the total number of information bits that are able to be transmitted by the UE, with the PT-RS, may be calculated in accordance with:

$${M}^{′} - y {N}_{samp}^{group} {N}_{group}^{PTRS} ,$$

where y is a number of symbols with the PT-RS. A block of complex-valued symbols may be divided into sets of complex-valued symbols, where each set may be mapped to one OFDM symbol. A size of the set may be given by a first option or a second option depending on a PT-RS adaptation.

In some aspects, when PT-RSs are being used, a block of complex-valued symbols x⁽⁰⁾(0), . . . ,

$${x}^{( 0 )} ( {M}_{symb}^{layer} - 1 )$$

may be divided into sets, where each set may correspond to one OFDM symbol. In the first option, set l may contain

$${M}_{sc}^{PUSCH} - {ε}_{l} {N}_{samp}^{group} {N}_{group}^{PTRS} - {δ}_{l} \frac{{M}_{sc}^{PUSCH}}{2} + \frac{1}{2} {δ}_{l} {ε}_{l} {N}_{samp}^{group} {N}_{group}^{PTRS}$$

symbols, where δₗ=1 when OFDM symbol l contains an uplink resource muting pattern, and δₗ=0 otherwise. In the second option, set l may contain

$${M}_{sc}^{PUSCH} - {ε}_{l} {N}_{samp}^{group} {N}_{group}^{PTRS} - {δ}_{l} \frac{{M}_{sc}^{PUSCH}}{2}$$

symbols, where δₗ=1 when OFDM symbol l contains an uplink resource muting pattern, and δₗ=0 otherwise. The set l may be mapped to complex-valued symbols

$${\tilde{x}}^{( 0 )} ( l {M}_{sc}^{PUSCH} + {i}^{′} )$$

corresponding to OFDM symbol l prior to a transform precoding, with i′∈{0,1, . . . ,

$${M}_{sc}^{PUSCH} - 1 \}$$

and i′≠m. An index m of PT-RS samples in set l, a number of samples per PT-RS group

$${N}_{samp}^{group} ,$$

and a number of PT-RS groups

$${N}_{group}^{PT - RS}$$

may be defined. A quantity εₗ=1 when OFDM symbol l contains one or more PT-RS samples, otherwise εₗ=0. In this example,

$${N}_{samp}^{group}$$

is the number of samples per PT-RS group, and

$${N}_{group}^{PTRS}$$

is the number of PT-RS groups.

As shown by reference number 908, the UE may perform, based at least in part on the configuration, a transform precoding in accordance with the DFT-s-OFDM waveform. In some aspects, the transform precoding may be based at least in part on the DFT size and the input sequence that is generated based at least in part on repeated information symbols. The transform precoding may be for OFDM symbols with uplink resource muting. The UE may generate the sequence based at least in part on a phase ramp pre-DFT or a circular shift post-DFT. In some aspects, the transform precoding may be based at least in part on the input sequence that is generated based at least in part on the half DFT size (e.g., the smaller DFT size) that is applied to OFDM symbols with uplink resource muting

In some aspects, for mapping to the DFT input and performing the transform precoding, when the uplink resource muting is based at least in part on the same DFT size across all OFDM symbols with a complex-valued symbol repetition in uplink resource muting symbols, then for an OFDM symbol with RE-level muting, a sequence x̌ of size

$${M}_{sc}^{PUSCH}$$

may be defined. When a comb-offset is equal to 0, the sequence x̌ may be generated by repeating sequence x, pre DFT, in accordance with:

$$\check{x} ( i ) = x ( i mod \frac{{M}_{sc}^{PUSCH}}{2} ) i = 0 , 1 , … , {M}_{sc}^{PUSCH} - 1 .$$

When the comb-offset is equal to 1, the sequence x̌ may be generated by multiplying with a phase ramp, in accordance with:

$$\check{x} ( i ) = x ( i mod \frac{{M}_{sc}^{PUSCH}}{2} ) * {e}^{j \frac{2 * π * {ik}^{′}}{{M}_{sc}^{PUSCH}}} ,$$

where k′=RE-offset {0 or 1}. Alternatively, when the comb-offset is equal to 1, the sequence x̌ may be generated by applying a circular shift in a frequency domain after the DFT (e.g., no phase ramp). In this example, y(k) may be replaced with y(k+1) in a DFT equation.

In some aspects, when the uplink resource muting is based at least in part on the same DFT size across all OFDM symbols with the complex-valued symbols repetition in the uplink resource muting symbols, then for the OFDM symbol with the RE-level muting, the transform precoding may be applied on the sequence x̌(i). In some aspects, the transform precoding may be applied in accordance with:

$${y}^{( 0 )} ( l \cdot {M}_{sc}^{PUSCH} + k ) = \frac{1}{\sqrt{{M}_{sc}^{PUSCH}}} {\sum }_{i = 0}^{{M}_{sc}^{PUSCH} - 1} {\check{x}}^{( 0 )} ( {\sum }_{s = 0}^{l} {M}_{sc , s}^{PUSCH} + i ) {e}^{- j \frac{2 π i k}{{M}_{sc}^{PUSCH}}} \\ k = 0 , … , {M}_{sc}^{PUSCH} - 1 \\ l = 0 , … , {M}_{symb}^{layer} / {M}_{sc}^{PUSCH} - 1 ,$$

which may result in a block of complex-valued symbols y⁽⁰⁾(0), . . . ,

$${y}^{( 0 )} ( {M}_{symb}^{layer} - 1 ) .$$

### Further,

$${M}_{sc}^{PUSCH} = {M}_{RB}^{PUSCH} \cdot {N}_{sc}^{RB} , where {M}_{RB}^{PUSCH}$$

represents a bandwidth of a PUSCH in terms of RBs and

$${N}_{sc}^{RB}$$

represents a number of subcarriers per RB, and may fulfill:

$${M}_{RB}^{PUSCH} = {2}^{{α}_{2}} \cdot {3}^{{α}_{3}} \cdot {5}^{{α}_{5}} ,$$

where α₂, α₃, α₅ is a set of non-negative integers. In this example,

$$\check{x} ( i ) = x ( i mod \frac{{M}_{sc}}{2} ) * {e}^{j \frac{2 * π * {ik}^{′}}{{M}_{sc}}} ,$$

where k′=RE-offset {0 or 1}. For symbol l,

$${M}_{sc , l}^{PUSCH} = {M}_{sc}^{PUSCH} - {δ}_{l} \frac{{M}_{sc}^{PUSCH}}{2} ,$$

and a total up to symbol l is

$${Σ}_{s = 0}^{l} {M}_{sc , s}^{P U S C H} .$$

In some aspects, for mapping to the DFT input and performing the transform precoding, when the uplink resource muting is based at least in part on different DFT size OFDM symbols, a size of the complex-valued symbols x̌ and a DFT size is given by

$${M}_{sc , l}^{P U S C H}$$

in accordance with:

$${M}_{sc , l}^{P U S C H} = \{ \begin{matrix}{M}_{sc}^{PUSCH} , & OFDM symbol ( l ) does not contain muted RE \\ \frac{{M}_{sc}^{PUSCH}}{2} , & OFDM symbol ( l ) contains muted RE\end{matrix}$$

In some aspects, the transform coding may be applied on the sequence x̌, and an RE-offset may be captured as some variable k′ that takes a value of 0 or 1 (e.g., y(2k+k′)). In some aspects, the transform precoding may be applied in accordance with:

$${y}^{( 0 )} ( l \cdot {M}_{sc}^{PUSCH} + 2 k + {k}^{′} ) = \frac{1}{\sqrt{{M}_{sc , l}^{P U S C H}}} {\sum }_{i = 0}^{{M}_{sc , l}^{P U S C H} - 1} {\tilde{x}}^{( 0 )} ( {\sum }_{s = 0}^{l} {M}_{sc , s}^{P U S C H} + i ) {e}^{- j \frac{2 π ik}{{M}_{sc , l}^{P U S C H}}}$$

$$k = 0 , , {M}_{sc}^{PUSCH} - 1$$

$$l = 0 , , {M}_{symb}^{layer} / {M}_{sc}^{PUSCH} - 1 ,$$

which may result in a block of complex-valued symbols y⁽⁰⁾(0), . . . ,

$${y}^{( 0 )} ( {M}_{s y m b}^{layer} - 1 ) .$$

### Further,

$${M}_{sc}^{P U S C H} = {M}_{R B}^{PUSCH} \cdot {N}_{sc}^{R B} , where {M}_{R B}^{PUSCH}$$

represents a bandwidth of a PUSCH in terms of RBs and

$${N}_{s c}^{R B}$$

represents a number of subcarriers per RB, and may fulfill:

$${M}_{R B}^{PUSCH} = {2}^{{α}_{2}} \cdot {3}^{{α}_{3}} \cdot {5}^{{α}_{5}} ,$$

where α₂, α₃, α₅ is a set of non-negative integers.

As shown by reference number 910, the UE may determine, based at least in part on a standard definition or the UE capability signaling, the PT-RS assignment of the one or more PT-RS symbols in the uplink transmission, where the PT-RS assignment may be for OFDM symbols with uplink resource muting. The PT-RS assignment in the uplink transmission may be based at least in part on the number of PT-RS groups and the number of PT-RS samples per PT-RS group. The PT-RS assignment in the uplink transmission may be based at least in part on a first half of an OFDM symbol. In one example, only PT-RS groups in the first half of the OFDM symbol may be applied, and the PT-RS groups may be repeated in a second half of the OFDM symbol. In another example, a predefined total number of PT-RS groups per OFDM symbol may be inserted into the first half of the OFDM symbol, and the predefined total number of PT-RS groups may be repeated in the second half of the OFDM symbol.

In some aspects, for the uplink resource muting that overlaps with the PT-RS, the PT-RS assignment may be determined. When the uplink resource muting is present, PT-RS samples may be inserted into a same number of PT-RS groups, as compared to a legacy approach, which may assume that the DFT size is the same as the legacy approach. The same DFT size may be across all OFDM symbols with a complex-valued symbol repetition in uplink resource muting symbols. The PT-RS samples may be associated with a same PT-RS sequence as the legacy approach, which may break a comb-2 structure as the PT-RS samples may not be identical in different PT-RS groups.

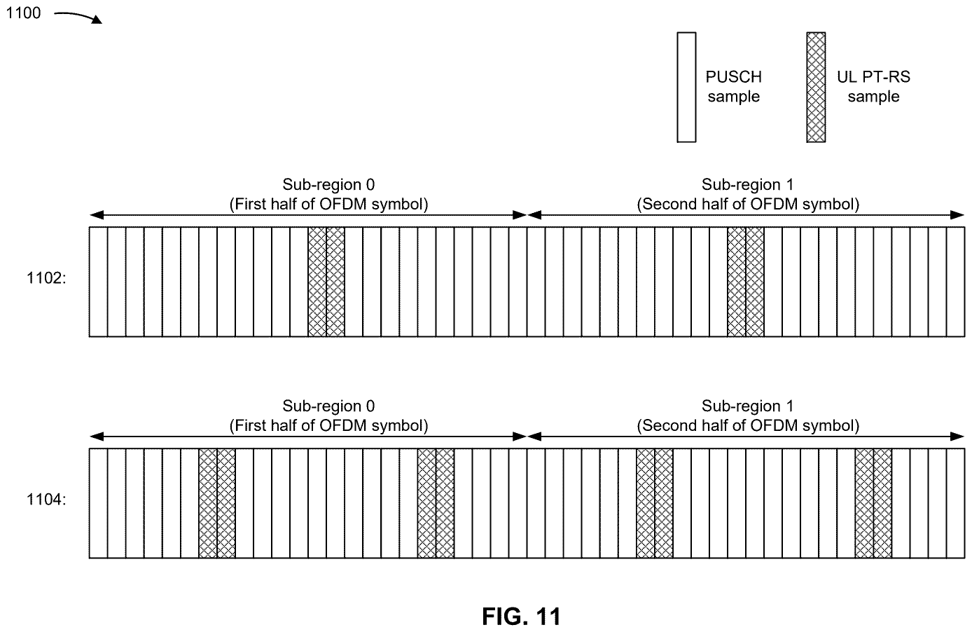

In some aspects, for the uplink resource muting that overlaps with the PT-RS, the PT-RS assignment may be determined. When the uplink resource muting is present, only a first half of an OFDM symbol may be considered for a PT-RS insertion. In a first option (e.g., as shown by reference number 1102 in FIG. 11), a number of PT-RS groups may be reduced to half, such that only a first half of the PT-RS groups may be considered. For the same DFT size, a repetition may be applied for a second half of the PT-RS groups. Alternatively, only half of an original number of PT-RS groups may be inserted pre-DFT, and a comb-2 structure may apply to the repetition. In a second option (e.g., as shown by reference number 1104 in FIG. 11), a PT-RS pattern may be adapted per symbol. The PT-RS pattern may involve a same number of PT-RS groups, but the PT-RS groups may be inserted in the first half of the OFDM symbol. In this case,

$${M}_{sc , l}^{P U S C H}$$

may be in accordance with:

$${M}_{sc , l}^{P U S C H} = \{ \begin{matrix}{M}_{sc}^{P U S C H} , & l not muted symbol \\ \frac{{M}_{sc}^{PUSCH}}{2} & l is a muted symbol\end{matrix} .$$

A repetition of the first half of the OFDM symbol may effectively double the PT-RS density. Alternatively, the PT-RS groups may be inserted pre-DFT in the first half of the OFDM symbol.

In some aspects, a number of information symbols that are able to be sent on each OFDM symbol corresponding to set l may be determined. A PT-RS overhead may be half of an original overhead, as only half of an OFDM symbol may be considered. In this example, set l may contain

$${M}_{sc}^{P U S C H} - {ε}_{l} {N}_{samp}^{group} {N}_{group}^{PTRS} - {δ}_{l} \frac{{M}_{sc}^{P U S C H}}{2} + \frac{1}{2} {δ}_{l} {ε}_{l} {N}_{samp}^{group} {N}_{group}^{PTRS}$$

symbols, where δₗ=1 when OFDM symbol l contains an uplink resource muting pattern, and δₗ=0 otherwise. A number of PT-RS samples may not be the same as in a legacy approach, as the PT-RS density may be doubled in the first half of the OFDM symbol. In this example, set l may contain

$${M}_{sc}^{P U S C H} - {ε}_{l} {N}_{samp}^{group} {N}_{group}^{PTRS} - {δ}_{l} \frac{{M}_{sc}^{P U S C H}}{2}$$

symbols, where δₗ=1 when OFDM symbol l contains an uplink resource muting pattern, and δₗ=0 otherwise.

In some aspects, for a DFT-s-OFDM waveform generation, whether the UE follows the first implementation (e.g., same DFT size, as shown by reference number 802 in FIG. 8) or the second implementation (e.g., smaller DFT size, as shown by reference number 804 in FIG. 8) may be based at least in part on a UE implementation and/or the UE capability report to the network node. In some aspects, for the DFT-s-OFDM waveform generation, whether the PT-RS assignment follows a first implementation (e.g., PT-RS inserted in the same number of PT-RS groups as the legacy approach) or a second implementation (e.g., only the first half of the OFDM symbol is considered for the PT-RS insertion) may be based at least in part on a standard definition and/or the UE capability reporting to the network node.

As shown by reference number 912, the UE may transmit, to the network node, the uplink transmission based at least in part on the configuration. The uplink transmission may be associated with the uplink resource muting and the one or more information symbols and/or the one or more PT-RS symbols. The uplink transmission may be based at least in part on a mapping of the one or more information symbols and/or the one or more PT-RS symbols, where the mapping may be based at least in part on the configuration. The uplink transmission may include OFDM symbols with uplink resource muting. The uplink transmission may or may not include the PT-RS. The uplink transmission may include the PUSCH samples.

As indicated above, FIG. 9 is provided as an example. Other examples may differ from what is described with regard to FIG. 9.

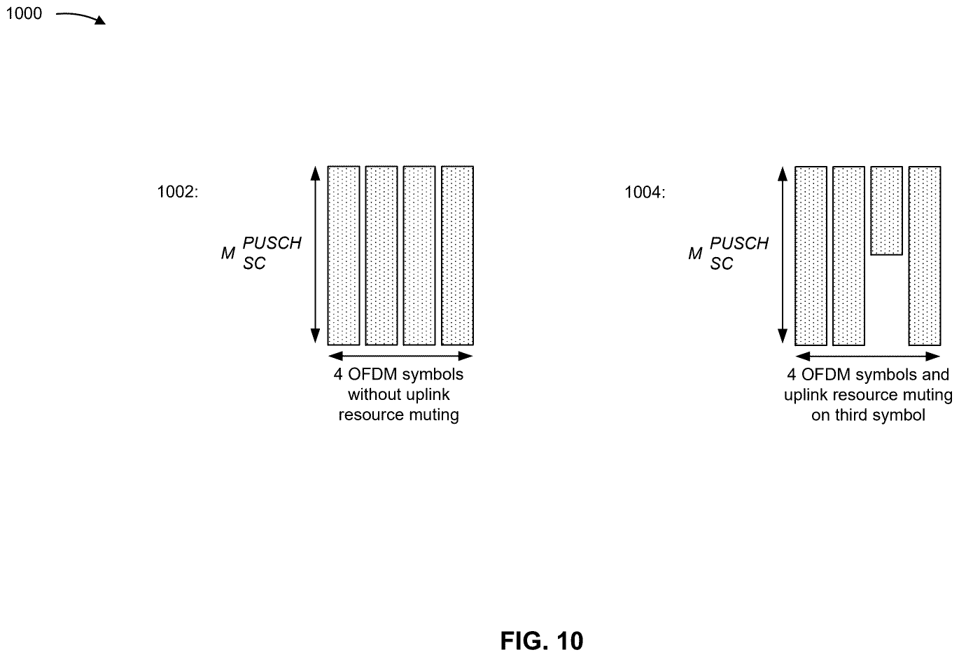

FIG. 10 is a diagram illustrating an example 1000 associated with uplink resource muting and PT-RSs for DFT-s-OFDM waveforms, in accordance with the present disclosure.

As shown by reference number 1002, uplink resource muting may not be configured or enabled for a PUSCH with a transform precoder enabled (e.g., DFT-s-OFDM). In this example, four OFDM symbols may be without the uplink resource muting. The four OFDM symbols may be associated with M_{sc}^{PUSCH} in a frequency domain. The four OFDM symbols may be without a PT-RS.

As shown by reference number 1004, uplink resource muting may be configured or enabled for a PUSCH with a transform precoder enabled (e.g., DFT-s-OFDM). In this example, in four OFDM symbols, the uplink resource muting may be applied in a third OFDM symbol of the four OFDM symbols. A portion of the third OFDM symbol, in a frequency domain, may be associated with the uplink resource muting. The four OFDM symbols may be associated with M_{sc}^{PUSCH} in a frequency domain. The four OFDM symbols may be without a PT-RS.

As indicated above, FIG. 10 is provided as an example. Other examples may differ from what is described with regard to FIG. 10.

FIG. 11 is a diagram illustrating an example 1100 associated with uplink resource muting and PT-RSs for DFT-s-OFDM waveforms, in accordance with the present disclosure.

As shown by reference number 1102, a number of PT-RS groups may be reduced to half, which may cause a first sub-region of an OFDM symbol (e.g., a first half of the OFDM symbol) to include one PT-RS group. The PT-RS group may be repeated for a second sub-region of the OFDM symbol (e.g., a second half of the OFDM symbol). In this example, the OFDM symbol may include two PT-RS groups (4 PT-RS samples). In this example, a total number of PT-RS samples/groups in the OFDM symbol may still be the same as a prior approach, but a difference is that only half of the PT-RS samples/groups may be generated, which may correspond to the first sub-region (or first half) of the OFDM symbol. The second sub-region (or second half) of the OFDM symbol may have the same PT-RS samples/groups due to either repetition or by using a comb-2 mapping.

As shown by reference number 1104, a number of PT-RS groups may be inserted in a first sub-region of an OFDM symbol (e.g., a first half of the OFDM symbol). The number of PT-RS groups may be inserted in a second sub-region of the OFDM symbol (e.g., a second half of the OFDM symbol), which may effectively double a PT-RS density in the OFDM symbol. In this example, the OFDM symbol may include four PT-RS groups (8 PT-RS samples).

As indicated above, FIG. 11 is provided as an example. Other examples may differ from what is described with regard to FIG. 11.

FIG. 12 is a diagram illustrating an example process 1200 performed, for example, at a UE or an apparatus of a UE, in accordance with the present disclosure. Example process 1200 is an example where the apparatus or the UE (e.g., UE 120) performs operations associated with uplink resource muting and PT-RSs for DFT-s-OFDM waveforms.

As shown in FIG. 12, in some aspects, process 1200 may include receiving a configuration associated with one or more of an uplink resource muting or a PT-RS for a DFT-s-OFDM waveform (block 1210). For example, the UE (e.g., using reception component 1402 and/or communication manager 1406, depicted in FIG. 14) may receive a configuration associated with one or more of an uplink resource muting or a PT-RS for a DFT-s-OFDM waveform, as described above.

As further shown in FIG. 12, in some aspects, process 1200 may include transmitting an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration (block 1220). For example, the UE (e.g., using transmission component 1404 and/or communication manager 1406, depicted in FIG. 14) may transmit an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration, as described above.

Process 1200 may include additional aspects, such as any single aspect or any combination of aspects described below and/or in connection with one or more other processes described elsewhere herein.

In a first aspect, the configuration indicates that the uplink resource muting for the DFT-s-OFDM waveform is based at least in part on a DFT size and an input sequence that is generated based at least in part on repeated information symbols.

In a second aspect, alone or in combination with the first aspect, the configuration indicates that the uplink resource muting for the DFT-s-OFDM waveform is based at least in part on a half DFT size and a changed RE mapping.

In a third aspect, alone or in combination with one or more of the first and second aspects, process 1200 includes determining, based at least in part on the configuration, a total number of information symbols that are permitted to be transmitted as part of the uplink transmission when the uplink resource muting is configured for a PUSCH with the DFT-s-OFDM waveform.

In a fourth aspect, alone or in combination with one or more of the first through third aspects, the PT-RS is not transmitted, wherein the total number of information bits is based at least in part on a number of OFDM symbols with the uplink resource muting, a number of PUSCH symbols, and a scheduled bandwidth for the uplink transmission, and a block of complex-valued symbols is divided into sets where each set is mapped to one OFDM symbol.

In a fifth aspect, alone or in combination with one or more of the first through fourth aspects, the PT-RS is present, wherein the total number of information bits is based at least in part on a number of symbols with the PT-RS, a number of PT-RS groups, and a number of PT-RS samples per PT-RS group, and a block of complex-valued symbols is divided into sets where each set is mapped to one OFDM symbol.

In a sixth aspect, alone or in combination with one or more of the first through fifth aspects, process 1200 includes performing, based at least in part on the configuration, a transform precoding in accordance with the DFT-s-OFDM waveform, wherein the transform precoding is based at least in part on a DFT size and an input sequence that is generated based at least in part on repeated information symbols, and the transform precoding is for OFDM symbols with uplink resource muting.

In a seventh aspect, alone or in combination with one or more of the first through sixth aspects, the sequence is generated based at least in part on a phase ramp pre-DFT or a circular shift post-DFT.

In an eighth aspect, alone or in combination with one or more of the first through seventh aspects, process 1200 includes performing, based at least in part on the configuration, a transform precoding in accordance with the DFT-s-OFDM waveform, wherein the transform precoding is based at least in part on a sequence that is generated based at least in part on a DFT size that is applied to OFDM symbols with uplink resource muting.

In a ninth aspect, alone or in combination with one or more of the first through eighth aspects, process 1200 includes determining, based at least in part on a standard definition or a UE capability signaling, a PT-RS assignment of the one or more PT-RS symbols in the uplink transmission, and the PT-RS assignment is for OFDM symbols with uplink resource muting.

In a tenth aspect, alone or in combination with one or more of the first through ninth aspects, the PT-RS assignment in the uplink transmission is based at least in part on a number of PT-RS groups and a number of PT-RS samples per PT-RS group.

In an eleventh aspect, alone or in combination with one or more of the first through tenth aspects, the PT-RS assignment in the uplink transmission is based at least in part on a first half of an OFDM symbol.

In a twelfth aspect, alone or in combination with one or more of the first through eleventh aspects, only PT-RS groups in the first half of the OFDM symbol are applied, and the PT-RS groups are repeated in a second half of the OFDM symbol.

In a thirteenth aspect, alone or in combination with one or more of the first through twelfth aspects, a predefined total number of PT-RS groups per OFDM symbol are inserted into the first half of the OFDM symbol, and the predefined total number of PT-RS groups are repeated in a second half of the OFDM symbol.

In a fourteenth aspect, alone or in combination with one or more of the first through thirteenth aspects, process 1200 includes transmitting a UE capability report, wherein the configuration is received based at least in part on the UE capability report.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a network node or an apparatus of a network node, in accordance with the present disclosure. Example process 1300 is an example where the apparatus or the network node (e.g., network node 110) performs operations associated with uplink resource muting and PT-RSs for DFT-s-OFDM waveforms.

As shown in FIG. 13, in some aspects, process 1300 may include transmitting a configuration associated with one or more of an uplink resource muting or a PT-RS for a DFT-s-OFDM waveform (block 1310). For example, the network node (e.g., using transmission component 1504 and/or communication manager 1506, depicted in FIG. 15) may transmit a configuration associated with one or more of an uplink resource muting or a PT-RS for a DFT-s-OFDM waveform, as described above.

As further shown in FIG. 13, in some aspects, process 1300 may include receiving an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration (block 1320). For example, the network node (e.g., using reception component 1502 and/or communication manager 1506, depicted in FIG. 15) may receive an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration, as described above.

Process 1300 may include additional aspects, such as any single aspect or any combination of aspects described below and/or in connection with one or more other processes described elsewhere herein.

In a first aspect, the configuration indicates that the uplink resource muting for the DFT-s-OFDM waveform is based at least in part on a DFT size and an input sequence that is generated based at least in part on repeated information symbols.

In a second aspect, alone or in combination with the first aspect, the configuration indicates that the uplink resource muting for the DFT-s-OFDM waveform is based at least in part on a half DFT size and a changed RE mapping.

In a third aspect, alone or in combination with one or more of the first and second aspects, a total number of information symbols that are permitted to be transmitted as part of the uplink transmission when the uplink resource muting is configured for a PUSCH with the DFT-s-OFDM waveform is based at least in part on the configuration.

In a fourth aspect, alone or in combination with one or more of the first through third aspects, the PT-RS is not transmitted, wherein the total number of information bits is based at least in part on a number of OFDM symbols with the uplink resource muting, a number of PUSCH symbols, and a scheduled bandwidth for the uplink transmission, and a block of complex-valued symbols is divided into sets where each set is mapped to one OFDM symbol.

In a fifth aspect, alone or in combination with one or more of the first through fourth aspects, the PT-RS is present, wherein the total number of information bits is based at least in part on a number of symbols with the PT-RS, a number of PT-RS groups, and a number of PT-RS samples per PT-RS group, and a block of complex-valued symbols is divided into sets where each set is mapped to one OFDM symbol.

In a sixth aspect, alone or in combination with one or more of the first through fifth aspects, a transform precoding in accordance with the DFT-s-OFDM waveform is based at least in part on the configuration, wherein the transform precoding is based at least in part on a DFT size and an input sequence that is generated based at least in part on repeated information symbols, and the transform precoding is for OFDM symbols with uplink resource muting.

In a seventh aspect, alone or in combination with one or more of the first through sixth aspects, the sequence is generated based at least in part on a phase ramp pre-DFT or a circular shift post-DFT.

In an eighth aspect, alone or in combination with one or more of the first through seventh aspects, a transform precoding in accordance with the DFT-s-OFDM waveform is based at least in part on the configuration, wherein the transform precoding is based at least in part on a sequence that is generated based at least in part on a DFT size that is applied to OFDM symbols with uplink resource muting.

In a ninth aspect, alone or in combination with one or more of the first through eighth aspects, a PT-RS assignment in the uplink transmission is based at least in part on a standard definition or a UE capability signaling, and wherein the PT-RS assignment is for OFDM symbols with uplink resource muting.

In a tenth aspect, alone or in combination with one or more of the first through ninth aspects, the PT-RS assignment of the one or more PT-RS symbols in the uplink transmission is based at least in part on a number of PT-RS groups and a number of PT-RS samples per PT-RS group.

In an eleventh aspect, alone or in combination with one or more of the first through tenth aspects, the PT-RS assignment in the uplink transmission is based at least in part on a first half of an OFDM symbol.

In a twelfth aspect, alone or in combination with one or more of the first through eleventh aspects, only PT-RS groups in the first half of the OFDM symbol are applied, and the PT-RS groups are repeated in a second half of the OFDM symbol.

In a thirteenth aspect, alone or in combination with one or more of the first through twelfth aspects, a predefined total number of PT-RS groups per OFDM symbol are inserted into the first half of the OFDM symbol, and the predefined total number of PT-RS groups are repeated in a second half of the OFDM symbol.

In a fourteenth aspect, alone or in combination with one or more of the first through thirteenth aspects, process 1300 includes receiving a UE capability report, wherein the configuration is received based at least in part on the UE capability report.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 140 described in connection with FIG. 1) of the UE.

In some aspects, the apparatus 1400 may be configured to perform one or more operations described herein in connection with FIGS. 8-11. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the UE described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the UE described above in connection with FIG. 1, such as a radio, one or more RF chains, one or more transceivers, or one or more modems, each of which may in turn be coupled with one or more antennas of the UE.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1404 may be co-located with the reception component 1402.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive a configuration associated with one or more of an uplink resource muting or a PT-RS for a DFT-s-OFDM waveform. The transmission component 1404 may transmit an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration.

The communication manager 1406 may determine, based at least in part on the configuration, a total number of information symbols that are permitted to be transmitted as part of the uplink transmission when the uplink resource muting is configured for a PUSCH with the DFT-s-OFDM waveform. The communication manager 1406 may perform, based at least in part on the configuration, a transform precoding in accordance with the DFT-s-OFDM waveform, wherein the transform precoding is based at least in part on a DFT size and an input sequence that is generated based at least in part on repeated information symbols, and the transform precoding is for OFDM symbols with uplink resource muting.

The communication manager 1406 may perform, based at least in part on the configuration, a transform precoding in accordance with the DFT-s-OFDM waveform, wherein the transform precoding is based at least in part on a sequence that is generated based at least in part on a DFT size that is applied to OFDM symbols with uplink resource muting. The communication manager 1406 may determine, based at least in part on a standard definition or a UE capability signaling, a PT-RS assignment of the one or more PT-RS symbols in the uplink transmission, and the PT-RS assignment is for OFDM symbols with uplink resource muting. The transmission component 1404 may transmit a UE capability report, wherein the configuration is received based at least in part on the UE capability report.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 155 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 145 described in connection with FIG. 1) of the network node.

In some aspects, the apparatus 1500 may be configured to perform one or more operations described herein in connection with FIGS. 8-11. Additionally, or alternatively, the apparatus 1500 may be configured to perform one or more processes described herein, such as process 1300 of FIG. 13, or a combination thereof. In some aspects, the apparatus 1500 and/or one or more components shown in FIG. 15 may include one or more components of the network node described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the network node described above in connection with FIG. 1, such as a radio, one or more RF chains, one or more transceivers, or one or more modems, each of which may in turn be coupled with one or more antennas of the network node. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1504 may be co-located with the reception component 1502.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may transmit a configuration associated with one or more of an uplink resource muting or a PT-RS for a DFT-s-OFDM waveform. The reception component 1502 may receive an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration. The reception component 1502 may receive a UE capability report, wherein the configuration is received based at least in part on the UE capability report.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving a configuration associated with one or more of an uplink resource muting or a phase tracking reference signal (PT-RS) for a discrete Fourier transform (DFT) spread orthogonal frequency division multiplexing (OFDM) (DFT-s-OFDM) waveform; and transmitting an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration.

Aspect 2: The method of Aspect 1, wherein the configuration indicates that the uplink resource muting for the DFT-s-OFDM waveform is based at least in part on a DFT size and an input sequence that is generated based at least in part on repeated information symbols.

Aspect 3: The method of any of Aspects 1-2, wherein the configuration indicates that the uplink resource muting for the DFT-s-OFDM waveform is based at least in part on a half DFT size and a changed resource element (RE) mapping.

Aspect 4: The method of any of Aspects 1-3, further comprising: determining, based at least in part on the configuration, a total number of information symbols that are permitted to be transmitted as part of the uplink transmission when the uplink resource muting is configured for a physical uplink shared channel (PUSCH) with the DFT-s-OFDM waveform.

Aspect 5: The method of Aspect 4, wherein the PT-RS is not transmitted, wherein the total number of information bits is based at least in part on a number of OFDM symbols with the uplink resource muting, a number of PUSCH symbols, and a scheduled bandwidth for the uplink transmission, and wherein a block of complex-valued symbols is divided into sets where each set is mapped to one OFDM symbol.

Aspect 6: The method of Aspect 4, wherein the PT-RS is present, wherein the total number of information bits is based at least in part on a number of symbols with the PT-RS, a number of PT-RS groups, and a number of PT-RS samples per PT-RS group, and wherein a block of complex-valued symbols is divided into sets where each set is mapped to one OFDM symbol.

Aspect 7: The method of any of Aspects 1-6, further comprising: performing, based at least in part on the configuration, a transform precoding in accordance with the DFT-s-OFDM waveform, wherein the transform precoding is based at least in part on a DFT size and an input sequence that is generated based at least in part on repeated information symbols, and wherein the transform precoding is for OFDM symbols with uplink resource muting.

Aspect 8: The method of Aspect 7, wherein the sequence is generated based at least in part on a phase ramp pre-DFT or a circular shift post-DFT.

Aspect 9: The method of any of Aspects 1-8, further comprising: performing, based at least in part on the configuration, a transform precoding in accordance with the DFT-s-OFDM waveform, wherein the transform precoding is based at least in part on a sequence that is generated based at least in part on a DFT size that is applied to OFDM symbols with uplink resource muting.

Aspect 10: The method of any of Aspects 1-9, further comprising: determining, based at least in part on a standard definition or a UE capability signaling, a PT-RS assignment of the one or more PT-RS symbols in the uplink transmission, and wherein the PT-RS assignment is for OFDM symbols with uplink resource muting.

Aspect 11: The method of Aspect 10, wherein the PT-RS assignment in the uplink transmission is based at least in part on a number of PT-RS groups and a number of PT-RS samples per PT-RS group.

Aspect 12: The method of Aspect 10, wherein the PT-RS assignment in the uplink transmission is based at least in part on a first half of an OFDM symbol.

Aspect 13: The method of Aspect 12, wherein only PT-RS groups in the first half of the OFDM symbol are applied, and wherein the PT-RS groups are repeated in a second half of the OFDM symbol.

Aspect 14: The method of Aspect 12, wherein a predefined total number of PT-RS groups per OFDM symbol are inserted into the first half of the OFDM symbol, and wherein the predefined total number of PT-RS groups are repeated in a second half of the OFDM symbol.

Aspect 15: The method of any of Aspects 1-14, further comprising: transmitting a UE capability report, wherein the configuration is received based at least in part on the UE capability report.

Aspect 16: A method of wireless communication performed by a network node, comprising: transmitting a configuration associated with one or more of an uplink resource muting or a phase tracking reference signal (PT-RS) for a discrete Fourier transform (DFT) spread orthogonal frequency division multiplexing (OFDM) (DFT-s-OFDM) waveform; and receiving an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration.

Aspect 17: The method of Aspect 16, wherein the configuration indicates that the uplink resource muting for the DFT-s-OFDM waveform is based at least in part on a DFT size and an input sequence that is generated based at least in part on repeated information symbols.

Aspect 18: The method of any of Aspects 16-17, wherein the configuration indicates that the uplink resource muting for the DFT-s-OFDM waveform is based at least in part on a half DFT size and a changed resource element (RE) mapping.

Aspect 19: The method of any of Aspects 16-18, wherein a total number of information symbols that are permitted to be transmitted as part of the uplink transmission when the uplink resource muting is configured for a physical uplink shared channel (PUSCH) with the DFT-s-OFDM waveform is based at least in part on the configuration.

Aspect 20: The method of Aspect 19, wherein the PT-RS is not transmitted, wherein the total number of information bits is based at least in part on a number of OFDM symbols with the uplink resource muting, a number of PUSCH symbols, and a scheduled bandwidth for the uplink transmission, and wherein a block of complex-valued symbols is divided into sets where each set is mapped to one OFDM symbol.

Aspect 21: The method of Aspect 19, wherein the PT-RS is present, wherein the total number of information bits is based at least in part on a number of symbols with the PT-RS, a number of PT-RS groups, and a number of PT-RS samples per PT-RS group, and wherein a block of complex-valued symbols is divided into sets where each set is mapped to one OFDM symbol.

Aspect 22: The method of any of Aspects 16-21, wherein a transform precoding in accordance with the DFT-s-OFDM waveform is based at least in part on the configuration, wherein the transform precoding is based at least in part on a DFT size and an input sequence that is generated based at least in part on repeated information symbols, and wherein the transform precoding is for OFDM symbols with uplink resource muting.

Aspect 23: The method of Aspect 22, wherein the sequence is generated based at least in part on a phase ramp pre-DFT or a circular shift post-DFT.

Aspect 24: The method of any of Aspects 16-23, wherein a transform precoding in accordance with the DFT-s-OFDM waveform is based at least in part on the configuration, wherein the transform precoding is based at least in part on a sequence that is generated based at least in part on a DFT size that is applied to OFDM symbols with uplink resource muting.

Aspect 25: The method of any of Aspects 16-24, wherein a PT-RS assignment in the uplink transmission is based at least in part on a standard definition or a user equipment (UE) capability signaling, and wherein the PT-RS assignment is for OFDM symbols with uplink resource muting.

Aspect 26: The method of Aspect 25, wherein the PT-RS assignment of the one or more PT-RS symbols in the uplink transmission is based at least in part on a number of PT-RS groups and a number of PT-RS samples per PT-RS group.

Aspect 27: The method of Aspect 25, wherein the PT-RS assignment in the uplink transmission is based at least in part on a first half of an OFDM symbol.

Aspect 28: The method of Aspect 27, wherein only PT-RS groups in the first half of the OFDM symbol are applied, and wherein the PT-RS groups are repeated in a second half of the OFDM symbol.

Aspect 29: The method of Aspect 27, wherein a predefined total number of PT-RS groups per OFDM symbol are inserted into the first half of the OFDM symbol, and wherein the predefined total number of PT-RS groups are repeated in a second half of the OFDM symbol.

Aspect 30: The method of any of Aspects 16-29, further comprising: receiving a user equipment (UE) capability report, wherein the configuration is received based at least in part on the UE capability report.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive a configuration associated with one or more of an uplink resource muting or a phase tracking reference signal (PT-RS) for a discrete Fourier transform (DFT) spread orthogonal frequency division multiplexing (OFDM) (DFT-s-OFDM) waveform; and
transmit an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration.

2. The apparatus of claim 1, wherein the configuration indicates that the uplink resource muting for the DFT-s-OFDM waveform is based at least in part on a DFT size and an input sequence that is generated based at least in part on repeated information symbols.

3. The apparatus of claim 1, wherein the configuration indicates that the uplink resource muting for the DFT-s-OFDM waveform is based at least in part on a half DFT size and a changed resource element (RE) mapping.

4. The apparatus of claim 1, wherein the one or more processors are further configured to cause the UE to:
determine, based at least in part on the configuration, a total number of information symbols that are permitted to be transmitted as part of the uplink transmission when the uplink resource muting is configured for a physical uplink shared channel (PUSCH) with the DFT-s-OFDM waveform.

5. The apparatus of claim 4, wherein the PT-RS is not transmitted, wherein the total number of information bits is based at least in part on a number of OFDM symbols with the uplink resource muting, a number of PUSCH symbols, and a scheduled bandwidth for the uplink transmission, and wherein a block of complex-valued symbols is divided into sets where each set is mapped to one OFDM symbol.

6. The apparatus of claim 4, wherein the PT-RS is transmitted, wherein the total number of information bits is based at least in part on a number of symbols with the PT-RS, a number of PT-RS groups, and a number of PT-RS samples per PT-RS group, and wherein a block of complex-valued symbols is divided into sets where each set is mapped to one OFDM symbol.

7. The apparatus of claim 1, wherein the one or more processors are further configured to cause the UE to:
perform, based at least in part on the configuration, a transform precoding in accordance with the DFT-s-OFDM waveform, wherein the transform precoding is based at least in part on a DFT size and an input sequence that is generated based at least in part on repeated information symbols, and wherein the transform precoding is for OFDM symbols with uplink resource muting.

8. The apparatus of claim 7, wherein the sequence is generated based at least in part on a phase ramp pre-DFT or a circular shift post-DFT.

9. The apparatus of claim 1, wherein the one or more processors are further configured to cause the UE to:
perform, based at least in part on the configuration, a transform precoding in accordance with the DFT-s-OFDM waveform, wherein the transform precoding is based at least in part on a sequence that is generated based at least in part on a DFT size that is applied to OFDM symbols with uplink resource muting.

10. The apparatus of claim 1, wherein the one or more processors are further configured to cause the UE to:
determine, based at least in part on a standard definition or a UE capability signaling, a PT-RS assignment of the one or more PT-RS symbols in the uplink transmission, and wherein the PT-RS assignment is for OFDM symbols with uplink resource muting.

11. The apparatus of claim 10, wherein the PT-RS assignment in the uplink transmission is based at least in part on a number of PT-RS groups and a number of PT-RS samples per PT-RS group.

12. The apparatus of claim 10, wherein the PT-RS assignment in the uplink transmission is based at least in part on a first half of an OFDM symbol.

13. The apparatus of claim 12, wherein only PT-RS groups in the first half of the OFDM symbol are applied, and wherein the PT-RS groups are repeated in a second half of the OFDM symbol.

14. The apparatus of claim 12, wherein a predefined total number of PT-RS groups per OFDM symbol are inserted into the first half of the OFDM symbol, and wherein the predefined total number of PT-RS groups are repeated in a second half of the OFDM symbol.

15. The apparatus of claim 1, wherein the one or more processors are further configured to cause the UE to:
transmit a UE capability report, wherein the configuration is received based at least in part on the UE capability report.

16. An apparatus for wireless communication at a network node, comprising:
one or more memories; and
one or more processors, coupled to the one or more memories, configured to cause the network node to:
transmit a configuration associated with one or more of an uplink resource muting or a phase tracking reference signal (PT-RS) for a discrete Fourier transform (DFT) spread orthogonal frequency division multiplexing (OFDM) (DFT-s-OFDM) waveform; and
receive an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration.

17. The apparatus of claim 16, wherein a total number of information symbols that are permitted to be transmitted as part of the uplink transmission when the uplink resource muting is configured for a physical uplink shared channel (PUSCH) with the DFT-s-OFDM waveform is based at least in part on the configuration.

18. The apparatus of claim 17, wherein the PT-RS is not transmitted, wherein the total number of information bits is based at least in part on a number of OFDM symbols with the uplink resource muting, a number of PUSCH symbols, and a scheduled bandwidth for the uplink transmission, and wherein a block of complex-valued symbols is divided into sets where each set is mapped to one OFDM symbol.

19. The apparatus of claim 17, wherein the PT-RS is transmitted, wherein the total number of information bits is based at least in part on a number of symbols with the PT-RS, a number of PT-RS groups, and a number of PT-RS samples per PT-RS group, and wherein a block of complex-valued symbols is divided into sets where each set is mapped to one OFDM symbol.

20. A method of wireless communication performed by a user equipment (UE), comprising:
receiving a configuration associated with one or more of an uplink resource muting or a phase tracking reference signal (PT-RS) for a discrete Fourier transform (DFT) spread orthogonal frequency division multiplexing (OFDM) (DFT-s-OFDM) waveform; and
transmitting an uplink transmission based at least in part on the configuration, wherein the uplink transmission is associated with the uplink resource muting and one or more of: one or more information symbols or one or more PT-RS symbols, and wherein a mapping of the one or more of the one or more information symbols or the one or more PT-RS symbols is based at least in part on the configuration.
